SEQUENCE LISTING (7 sequences)

SEQ ID NO: 1 - DNA, 88 bp, Artificial Sequence
  Description of Artificial Sequence Synthetic oligonucleotide
atctgcagggagtcaaccttgtccgtccattctaaaccgttgtgcgtccgtcccgattagaccaacccccctatagtgagtcgtatta

SEQ ID NO: 2 - DNA, 88 bp, Artificial Sequence
  Description of Artificial Sequence Synthetic oligonucleotide
atctgcaggccaggatgacacctagatcgtggtgatcgggagtgtgtccacgtgaccaacccctatagccctatagtgagtcgtatta

SEQ ID NO: 3 - DNA, 88 bp, Artificial Sequence; identical to SEQ ID NO: 2
  Description of Artificial Sequence Synthetic oligonucleotide

SEQ ID NO: 4 - DNA, 20 bp, Artificial Sequence
  Description of Artificial Sequence Synthetic oligonucleotide
ccctatagtgagtcgtatta

SEQ ID NO: 5 - DNA, 20 bp, Artificial Sequence
  Description of Artificial Sequence Synthetic oligonucleotide
taatacgactcactataggg

SEQ ID NO: 6 - DNA, 20 bp, Artificial Sequence
  Description of Artificial Sequence Synthetic oligonucleotide
tgtcatcctggcctgcagat

SEQ ID NO: 7 - DNA, 26 bp, Artificial Sequence
  Description of Artificial Sequence Synthetic oligonucleotide
gaattctaatacgactcactataggg

(19) United States
(12) Patent Application Publication
(10) Pub. No.: US 2008/0125333 A1
(43) Pub. Date: May 29, 2008

(54) Devices and kits for detecting one or more target agents

(75) Inventors: Marc R. Labgold, Reston, VA (US); George G. Jokhadze, Mountain View, CA (US); Bradley J. Scherer, Mountain View, CA (US); Mark T. Kozlowski, Mountain View, CA (US)

Correspondence Address: PATTON BOGGS LLP, 8484 WESTPARK DRIVE, SUITE 900, MCLEAN, VA, 22102, US

(73) Assignee: Antara BioSciences Inc.

(21) Appl. No.: 11/806,282

(22) Filed: May 31, 2007

Related U.S. Application Data
(60) Provisional application No. 60/809,543, filed on May 31, 2006.

(51) Int. Cl. C40B 60/12

(52) U.S. Cl. 506/39

(57) ABSTRACT

The present invention provides devices, kits, and methods for the detection of one or more target agents in a sample by rapid and specific electrochemical detection. The present invention includes kits, devices and compositions capable of performing rapid, specific and detection of one or more target agents in a sample.

### CROSS REFERENCE TO RELATED APPLICATIONS

This application claims the benefit of U.S. Provisional Patent Application Ser. No. 60/809,543, filed May 31, 2006, entitled “DEVICES AND KITS FOR DETECTING ONE OR MORE TARGET AGENTS,” currently pending, and which is incorporated herein by reference in its entirety for all purposes.

### BACKGROUND OF THE INVENTION

In the following discussion certain articles and methods will be described for background and introductory purposes. Nothing contained herein is to be construed as an “admission” of prior art. Applicant expressly reserves the right to demonstrate, where appropriate, that the articles and methods referenced herein do not constitute prior art under the applicable statutory provisions.

Enzyme-linked immunosorbent assay (ELISA) is a widely used method for measuring the concentration of a particular molecule (e.g., a hormone or drug) in a fluid such as serum or urine. It is also known as enzyme immunoassay or EIA. The molecule is detected by antibodies that have been made against it; that is, for which it is the antigen. Monoclonal antibodies are often used. Due to the diversity found in the immune system and the production of monoclonal antibodies from immortalized cells of the immune system, first described by Kohler and Milstein in 1975 (Kohler & Milstein, Nature. 1975 Aug. 7; 256(5517):495-7), antibodies can be raised against a huge number of different antigens by standard immunological techniques. Potentially any agent can be recognized by a specific antibody that will not react with any other agent.

An ELISA typically involves coating a vessel, such as a microtiter plate with an antibody specific for a particular antigen to be detected, e.g., a virus or bacteria, adding the sample suspected of containing the particular antigen or agent, allowing the antibody to bind the antigen and then adding at least one other antibody, specific to another region of the same agent to be detected. This use of two antibodies can be referred to as a “sandwich” ELISA. Sometimes, the second antibody or even a third antibody is used that is labeled with a chromogenic or fluorogenic reporter molecule to aid in detection. The procedure may also involve the need for a chemical substrate to produce a signal. The need for multiple antibodies, which do not cross-react with other agents, and the incubation steps involved mean that it is difficult to detect more than a single agent in a sample in a short time period.

Another method of detecting the presence of particular agents in a sample involves detecting the presence of nucleic acids. Several methods of detecting nucleic acids are available including PCR and hybridization techniques. PCR is well known in the art and is described in U.S. Pat. Nos. 4,683,195 and 4,683,202 to Mullis and Mullis et al., respectively. PCR is used for the amplification and detection of low levels of specific nucleic acid sequences. PCR can be used to directly increase the concentration of the target nucleic acid sequence to a more readily detectable level. A variant of PCR is the ligase chain reaction, or LCR, which uses polynucleotides that are ligated together during each cycle. PCR can suffer from non-specific amplification of non-target sequences. Other variants exist, but none have been as widely accepted as PCR.

Hybridization techniques involve detecting the hybridization of two or more nucleic acid molecules. Such detection can be achieved in a variety of ways, including labeling the nucleic acid molecules and observing the signal generated from such a label. Traditional methods of hybridization, including Northern and Southern blotting, were developed with the use of radioactive labels which are not amenable to automation. Radioactive labels have been largely replaced by fluorescent labels in most hybridization techniques. Representative forms of other hybridization techniques include the cycling probe reaction, branched DNA, Invader™ Assay, and hybrid capture.

The cycling probe reaction (CPR) (Duck et al., Biotechniques. 1990 August; 9(2):142-8) uses a long chimeric oligonucleotide in which a central portion is made of RNA while the two termini are made of DNA. CPR is generally described in U.S. Pat. Nos. 5,011,769, 5,403,711, 5,660,988, and 4,876,187, and PCT published applications WO 95/05480, WO 95/1416, and WO 95/00667, which are hereby incorporated by reference. Branched DNA (bDNA), described by Urdea et al., Gene 61: 253-264 (1987), involves oligonucleotides with branched structures that allow each individual oligonucleotide to carry 35 to 40 labels (e.g., alkaline phosphatase enzymes). While this enhances the signal from a hybridization event, signal from non-specific binding is similarly increased. The Invader™ Assay is based on structure-specific polymerases that cleave nucleic acids in a site-specific manner. Two probes are used: an “invader” probe and a “signaling” probe that adjacently hybridize to a target sequence with a non-complementary overlap. The enzyme cleaves at the overlap due to its recognition of the “flap”, and releases the “flap” with a label. This can then be detected. The Invader™ Assay technology is described in U.S. Pat. Nos. 5,846,717; 5,614,402; 5,719,028; 5,541,311; 5,843,669; 5,985,557; 6,001,567; 6,090,543; and 6,348,314 which are hereby incorporated by reference. However, the Invader™ Assay suffers from serious deficiencies including a lack of sensitivity making it unsuitable for various diagnostic applications including infectious disease applications.

The hybrid capture assay involves hybridizing a sample containing unknown nucleic acid sequences with nucleic acid probes that are specific for a target nucleic acid sequence, such as oncogenic and non-oncogenic HPV DNA sequences. The hybridization complexes are then bound to anti-hybrid antibodies immobilized on a solid phase. Non-hybridized probe is removed, by incubating the captured hybrids with an enzyme, such as RNase, that degrades non-hybridized probe. Hybridization is detected by either labeling the probe or using a labeled antibody, specific for the hybridization complex, in a similar manner to a “sandwich” ELISA. The Hybrid Capture Assay is described in U.S. Pat. No. 6,228,578, which technology is hereby incorporated by reference.

Many of these hybridization techniques, while overcoming the problem of non-specific nucleic acid amplification associated with PCR, lack the sensitivity required for many applications, especially infectious disease diagnostics. Hybridization detection techniques such as the cycling probe reaction and the Invader™ Assay that produce a linear amplification of the signaling molecule, rather than the exponential target amplification of PCR, are particularly lacking in the ability to be used for the detection of infectious disease agents, such as viruses and bacteria that may be present in low concentrations. Additionally, these techniques, because of the linear amplification of signal, can take substantial periods of time to accumulate a detectable signal.

PCR and hybridization techniques rely on the specificity of nucleic acid hybridization to distinguish between target and non-target nucleic acid. Two single-stranded nucleic acids will only hybridize to each other if they are sufficiently complementary to each other under the specific reaction conditions. It is possible to manipulate these conditions to ensure that only completely complementary nucleic acid molecules will hybridize to each other. This manipulation makes it possible to conduct tests simultaneously for many different sequences of nucleic acid that may be present in a sample without any substantial cross reactivity; however, the possibility of a particular nucleic acid molecule hybridizing to a non-target nucleic acid that may be present in a sample of unknown nucleic acid cannot be precluded. Additionally, indicating the presence of organisms by detecting specific nucleic acid sequences necessarily involves the extraction and isolation of nucleic acids, which can lead to cross-contamination between samples. Accordingly, even under the most stringent conditions there may be non-specific hybridization and cross-contamination that can give a false positive result when several nucleic acids of unknown sequence are present in a sample. Such false indications frequently arise due to factors including faulty isolation techniques.

Hybridization techniques can also be used to identify the specific sequence of nucleic acid present in the sample by using arrays of known nucleic acid sequences to probe a sample. Such techniques are described in U.S. Pat. No. 6,054,270, which is incorporated by reference. These techniques generally involve attaching short lengths of single-stranded nucleic acid to a surface, each unique short chain attached in a specific known location and then adding the sample nucleic acid and allowing sequences present in the sample to hybridize to the immobilized strands. Detection of this hybridization is then carried out by labeling, typically end labeling, of the fragments of the sample to be detected prior to the hybridization. When a sample fragment hybridizes to a specific strand on the array, a signal can be detected from the label, because the position of the hybridization reaction can be detected, and the sequence of the attached strand at that location is known, the sequence of the complementary strand from the sample that has hybridized can be deduced.

These hybridization techniques can be coupled with PCR to include amplification of the nucleic acid to be detected. Usually the detection of hybridization is by measuring a fluorescent signal; however, methods of detection using an electrochemical detection method have been disclosed. Electrochemical detection methods, and devices used in electrochemical detection methods, are discussed in U.S. Pat. Nos. 5,776,672, 5,972,692, 6,489,160, 6,667,155, 6,670131, 6,783,935, and 6,818,109, herein incorporated by reference. These electrochemical detection techniques can provide a result in a reduced time period compared to the fluorescent methods of hybridization detection and the potential for greater sensitivity. To date, only a system developed by Toshiba, has proven successful in practical electrochemical DNA detection using both Toshiba's Genelyzer™ instrument and the Bioanalytical Systems, Inc. BASi Electrochemical Workstation. As discussed above; however, whether fluorescent or electrochemical, these hybridization detection methods can be subject to false positives due to non-specific hybridization. Additionally, nucleic acid detection techniques requiring steps of nucleic acid extraction, isolation and purification may lengthen the time taken to achieve a result and also decrease the detection level of the test through the loss of nucleic acid molecules in the many washing steps involved in these isolation steps.

The nucleic acid detection techniques, while overcoming the potential problem of multiplexing associated with ELISA (i.e., the limited number of discriminatory signals), are restricted in use to only detecting nucleic acid. Therefore, agents such as proteins, drugs, hormones, chemical toxins, and prions, which do not contain nucleic acids, cannot be detected by these nucleic acid hybridization techniques.

### SUMMARY OF THE INVENTION

The present invention provides devices, kits and methods for the rapid and simple detection of target agents within a sample of interest. In certain embodiments, the kits and devices of the present invention solve the problem of multiplex detection for a wide range of target agents by combining the versatility of antibody recognition with the speed, sensitivity, and multiplexing capability of electrochemical detection of nucleic acid hybridization. The non-specific hybridization observed in other detection methods currently known in the art is overcome by using only known nucleic acid sequences for hybridization (sequences that, in a preferred embodiment, are rationally designed to minimize the risk of non-specific hybridization), thereby ensuring that specific hybridization indicating the presence of target nucleic acids is optimized. Also, the single-stranded nucleic acids, oligonucleotides, or oligos employed in the present invention can be of many lengths and sequences, but preferably have lengths and sequences that prevent non-specific hybridization to one another, and prevent non-specific hybridization to sequences that may be present in the sample (e.g., human genomic sequences or genomic sequences from pathogens when using biological samples that may naturally contain such pathogens). Such oligos may be termed “universal oligos” and are described in detail in copending U.S. patent application Ser. No. 11/703,103, filed Feb. 7, 2007, entitled “Device and Methods for Detecting and Quantifying One or More Target Agents,” and which is incorporated herein by reference in its entirety for all purposes. Also provided in U.S. Ser. No. 11/703,103 are additional methods and compositions appropriate for use with the present invention, as will be clear to one of ordinary skill in the art upon review of the relevant disclosures.

In one embodiment of the invention, a device is provided for detection of one or more of a specific, defined subset of target agents in a sample. The device comprises at least two reaction chambers which are connected in a manner to allow sequential and separate binding reactions to occur. In this device, the first reaction chamber contains a plurality of capture-associated oligo/capture moiety complexes, each capture moiety therein having the ability to specifically bind to a single target agent of the subset of target agents that may be present in a sample. The first reaction chamber is designed to hold liquid contents within the chamber for a period sufficient to allow an efficient binding reaction between the capture moieties of the first chamber and any target agent within the sample to create “reacted capture-associated oligo complexes.” Following this reaction, the device is designed to allow contact of the contents of the first reaction chamber with a second reaction chamber, and to keep the collective contents within the second chamber for a period sufficient to allow an efficient binding reaction between any unreacted capture moieties and the binding partners of the second chamber. For example, in some embodiments, the second reaction chamber of the device comprises an excess of each of the subset of target agents immobilized on a solid surface within the second chamber. The solid surface to which the binding partners are immobilized may be any solid surface that can be retained within the chamber following removal of any liquid contents of the chamber, e.g., a matrix within the chamber, beads of a sufficient size for retention in the chamber, or the surface of the chamber itself with immobilized target agent. This depletion process will allow isolation of the reacted capture-associated oligo complexes, thus providing the bound target agent and the capture-associated oligo for detection using the methods described herein. The reacted capture-associated oligo complex is removed from the second reaction chamber for detection.

In another embodiment of the invention, a second device is provided for detection of a specific, defined subset of target agents in a sample. The device comprises at least two reaction chambers which are connected in a manner to allow sequential binding reactions. The first chamber contains a plurality of capture-associated oligo/capture moiety complexes, each capture moiety therein having the ability to specifically bind to a single target agent of the subset of target agents that may be present in a sample. The first chamber is designed to hold liquid contents within the first chamber for a period sufficient to allow a binding reaction between the capture moieties of the first chamber and any target agent within the sample. Following this reaction, the device is designed to allow contact of the contents of the first chamber with a second reaction chamber for a period sufficient to allow an efficient binding reaction between any unreacted capture moieties and the binding agents of the second chamber. The second reaction chamber of the device thus comprises a plurality of immobilized binding partners, which will bind to an epitope specific to the reacted capture-associated oligo complex, e.g., either an unbound epitope of the target agent itself or an epitope formed by the binding of the target agent to the capture moiety. The immobilized binding partner is conjugated to a solid surface to allow capture of the reacted capture-associated oligo complex, thus providing the bound target agent and the capture oligos for detection using the methods described herein.

The devices of the invention are intended to be used for electrochemical detection in conjunction with a biosensor, as described in more detail herein. The biosensor is a central component of the kits of the invention, and the specifically designed complementarity of the biosensor-associated oligos and the capture oligos is a fundamental aspect of the success of the kits of the invention. Detection of the reacted capture-associated oligo complex is accomplished by introducing the isolated reacted capture-associated oligo complex to the biosensor, thus effecting an electrochemical signal. Certain examples of biosensors that may be used with the present invention are provided, e.g., in U.S. provisional patent application No. 60/802,950, filed May 24, 2006, entitled “Small Disposable Detection Device and Methods of Use Thereof;” U.S. provisional patent application No. 60/802,964, filed May 24, 2006, entitled “Electrochemical Detection Device with Reduced Footprint;” U.S. provisional patent application No. 60/815,106, filed Jun. 20, 2006, entitled “Electrochemical Detection Device with Reduced Footprint”, all of which are incorporated herein by reference in their entireties for all purposes.

In another specific embodiment, the invention provides a kit for determining the presence of one or more of a discrete subset of target agents in a test sample, said kit comprising a first reaction vessel containing a plurality of capture-associated oligo/capture moiety complexes, with each capture moiety therein designed to specifically bind to a single target agent of the discrete subset of agents; a second reaction vessel comprising an excess of binding partners (e.g., each of the subset of target agents or epitopes or fragments thereof) immobilized to a surface, wherein the target agents preferentially bind the unreacted capture-associated oligo complexes; and a biosensor comprising a plurality of biosensor-associated oligos, wherein each biosensor-associated oligo is complementary to a capture-associated oligo. The isolated reacted capture-associated oligo complexes are introduced to the biosensor, and capture-associated oligos on these complexes bind to the biosensor-associated oligos to form double-stranded nucleic acid molecules (“duplexes”). Formation of capture-associated oligo/biosensor-associated oligo duplexes is detected using electrochemical signaling, and is indicative of the presence of the target agent in a sample.

In some embodiments, the invention provides a kit for determining the presence of a target agent in a test sample, said kit comprising: 1) a single reaction vessel containing a plurality of capture-associated oligo/capture moiety complexes, each capture moiety therein designed to specifically bind to a single target agent; 2) a second holding vessel containing a plurality of binding partners for isolation of the reacted capture-associated oligo complexes and 3) a biosensor. The sample is added to the first reaction vessel as a solution, and following binding of any target agent in the sample with the capture-associated oligo/capture moiety complexes to form reacted capture-associated oligo complexes, a solution comprising a plurality of binding partners is added to the same vessel and allowed to bind to the reacted capture-associated oligo complexes. The isolated reacted capture-associated oligo complexes are removed from the reaction vessel and introduced to the biosensor, where capture-associated oligos bind to the biosensor-associated oligos to form form double-stranded nucleic acid molecules (“duplexes”). Formation of capture-associated oligo/biosensor-associated oligo duplexes is detected using electrochemical signaling, and is indicative of the presence of the target agent in a sample.

In another embodiment, the invention provides a kit comprising a device of the invention for determining the presence of one of a discrete subset of agents in a test sample. The kit comprises 1) a device comprising at least two chambers which are connected in a manner to allow sequential binding reactions and 2) a biosensor. The first chamber contains a plurality of capture-associated oligo/capture moiety complexes, each capture moiety therein having the ability to specifically bind to a single target agent of the subset of target agents that may be present in a sample. The first chamber is designed to hold liquid contents within the first chamber for a period sufficient to allow a binding reaction between the capture moieties of the first chamber and any target agent within the sample. The second chamber of the device comprises an excess of binding partners (e.g., each of the subset of target agents or epitopes or fragments thereof) immobilized on a solid surface within the second chamber, and contact of the reacted contents of the first chamber with these immobilized binding partners will allow isolation of the reacted capture-associated oligo complexes. The biosensor of the kit comprises a plurality of biosensor-associated oligos, each having a sequence complementary to the sequence of a capture-associated oligo. Binding of a capture-associated oligo to a biosensor-associated oligo is indicative of the presence in the sample of the target agent to which the capture moiety conjugated to the capture-associated oligo specifically binds.

In another embodiment, the invention provides a device for determining the presence of a target agent in a sample. The kit comprises 1) a device comprising at least two chambers which are connected in a manner to allow sequential binding reactions and 2) a biosensor. The first chamber contains a plurality of capture-associated oligo/capture moiety complexes and is designed to hold liquid contents within the first chamber for a period sufficient to allow a binding reaction between the capture moieties of the first chamber and any target agent within the sample. The second chamber of the device comprises a plurality of binding partners which will bind to either the target agent or to an epitope formed by the binding of the target agent to a capture moiety. The biosensor comprises a plurality of biosensor-associated oligos, each having a sequence complementary to that of a capture-associated oligo. Binding of a capture-associated oligo to a biosensor-associated oligo is indicative of the presence in the sample of the target agent to which the capture moiety conjugated to the capture-associated oligo specifically binds.

In one aspect of the invention, a restriction endonuclease can be used to remove the capture moiety from the capture-associated oligo prior to binding of the “released capture-associated oligo” to the biosensor-associated oligo. The restriction endonuclease may be included with the kit in a separate vessel.

In another aspect of the invention, the electrochemical signal on the biosensor is created by an electrochemically-active compound that specifically binds to double-stranded nucleic acids, e.g., a minor groove binding ligand such as the molecules of the netropsin family. Thus, in a specific embodiment, the kits of the invention further comprise a vessel containing a minor groove ligand.

In certain embodiments of the invention, it may be beneficial to use nucleic acid amplification to enhance the signal that will be created by the hybridization of the capture-associated oligo to the biosensor-associated oligo. In such embodiments, the binding region of capture-associated oligo will have substantially the same sequence as a biosensor-associated oligo. The capture-associated oligo is then used as a template for amplification of a single-stranded nucleic acid which is complementary to both the capture-associated oligo and the biosensor-associated oligo. By using this amplification, multiple complements of each capture-associated oligo will be created, and the sensitivity of the detection by the biosensor will be enhanced. In such embodiments, the kits can further comprise a vessel containing an oligonucleotide complementary to a polymerase recognition sequence on the capture-associated oligo. Other elements for the polymerization reaction can also be included in the kit, such as a polymerase, buffers, nucleotides, and the like.

In one specific aspect of this embodiment, the amplification is an isothermal amplification. In this aspect, the polymerase used to create the complementary nucleotide for binding to the biosensor is preferably an RNA phage polymerase. Exemplary RNA phage polymerases include T3 polymerase, T7 polymerase, and SP6 polymerase.

In another specific aspect of this embodiment, the amplification is an asymmetric amplification using a heat stable polymerase, e.g., Taq polymerase. The amplification may use an oligonucleotide that will initiate the polymerization either at the capture moiety-conjugated end of the capture-associated oligo or at the opposite end of the capture-associated oligo.

In yet another specific aspect of this embodiment, a restriction endonuclease can be used to remove the capture moiety from the capture-associated oligo prior to the amplification reaction. The restriction endonuclease may be included with the kit in a separate vessel.

These and other objects, advantages, and features of the invention will become apparent to those persons skilled in the art upon reading the details of the methods and formulations as more fully described below.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments that are illustrated in the appended drawings. It is to be noted, however, that the appended drawings illustrate only certain embodiments of this invention and are therefore not to be considered limiting of its scope, for the present invention may admit to other equally effective embodiments.

In the following figures, the filled rectangles (black or white) represent nucleic acid sequences, with the white rectangles representing nucleic acids complementary to the black sequences. The striped rectangle represents the conjugation structure linking the nucleic acid to the capture moiety. Capture moieties are represented by an arrow structure, and the target agent is represented by a pentagon. The substrate to which the immobilized binding partner is bound is represented by a circle or oval.

FIG. 1 is a schematic diagram demonstrating one embodiment of a method of using a kit of the invention to detect a target agent using isolation of reacted capture moieties via depletion of unreacted capture moieties. The kits and method comprise the following steps: A adding a sample suspected of containing one or more target agents from a specific subset of target agents to a vessel comprising an aqueous solution containing a plurality of capture moieties conjugated to capture-associated oligos; B transferring the entire contents of the first vessel to a second vessel, where the second vessel comprises an excess of each of the subset of the target agents immobilized to a surface, and allowing the unreacted capture moiety to bind to the immobilized agents, thus depleting the contents of all remaining unreacted capture moiety; C removing the contents of the vessel (minus the immobilized capture moieties), which includes the capture moieties bound to the target agent of interest; D introducing the collected contents to a biosensor of the kit, and E allowing binding of the contents to the complementary biosensor-associated oligos, effecting an electrochemical system that allows detection of the target agent.

FIG. 2 is a schematic diagram demonstrating a second method of using a kit of the invention to detect a target agent using isolation of reacted capture moieties via depletion of unreacted capture moieties. The method of the kit comprises the following steps: A adding a sample suspected of containing one or more target agents from a specific subset of target agents to the first chamber of a vessel comprising two or more chambers, where the first chamber contains a capture moiety conjugated to a capture-associated oligo and allowing any target agents in the sample to bind to the contents of the chamber; B transferring the entire contents of the first chamber the second chamber of the vessel, where the second vessel comprises an excess of each of the subset of the target agents immobilized to a surface, and allowing the unreacted capture moiety to bind to the surface, thus depleting the contents of all remaining unreacted capture moiety; C removing the remainder of the contents (minus the immobilized capture moieties), which includes the capture moieties bound to the target agent of interest; D introducing the collected contents to a biosensor of the kit, and E allowing binding of the contents to the complementary biosensor-associated oligos, effecting an electrochemical system that allows detection of the target agent.

FIG. 3 is a schematic diagram demonstrating a method of using a kit of the present invention to detect a target agent using a binding partner for isolation of a reacted capture-associated oligo complex. The method of the kit involves the following steps: A adding a sample suspected of containing one or more target agents from a specific subset of target agents to a vessel comprising a capture moiety conjugated to a capture-associated oligo; B adding a binding partner that binds to an epitope accessible on the target agent-capture moiety complex; C isolating the reacted capture-associated oligo complex bound to the binding partner from the vessel and D introducing the collected contents to a biosensor of the kit, and E allowing binding of the contents to the complementary biosensor-associated oligos, effecting an electrochemical system that allows detection of the target agent.

FIG. 4 is a schematic diagram demonstrating a second method of using a kit of the present invention to detect a target agent using a binding partner for isolation of a reacted capture-associated oligo complex. The method of the kit comprises the following steps: A adding a sample suspected of containing one or more target agents from a specific subset of target agents to the first chamber of a vessel comprising two or more chambers, where the first chamber contains a capture moiety conjugated to a capture-associated oligo and allowing any target agents in the sample to bind to the contents of the chamber; B. introducing the reacted capture-associated oligo complex to the second chamber, which contains a binding partner for isolation of the reacted capture-associated oligo complex; C isolating the reacted capture-associated oligo complex bound to the binding partner; D introducing it to the biosensor of the kit, and E allowing binding of the contents to the complementary biosensor-associated oligos, effecting an electrochemical system that allows detection of the target agent.

FIG. 5 is a schematic diagram demonstrating a third method of using a kit of the present invention to detect a target agent using a binding partner for isolation of a reacted capture-associated oligo complex. The method of the kit comprises the following steps: A adding a sample suspected of containing one or more target agents from a specific subset of target agents to a vessel comprising a capture moiety conjugated to a capture-associated oligo; B adding a binding partner that binds to an epitope available on the reacted capture-associated oligo complex; C isolating the reacted capture-associated oligo complex from the vessel; D cleaving the capture moiety from the reacted capture-associated oligo complex to produce “released capture-associated oligos;” E introducing the released capture-associated oligos to a biosensor of the kit, and F allowing binding of the released capture-associated oligos to the complementary biosensor-associated oligos, effecting an electrochemical system that allows detection of the target agent.

FIG. 6 is a schematic diagram demonstrating a fourth method of using a kit of the present invention to detect a target agent using a binding partner for isolation of a reacted capture-associated oligo complex. The method of the kit comprises the following steps: A adding a sample suspected of containing one or more target agents to the first chamber of a vessel comprising two or more chambers, where the first chamber contains a capture moiety conjugated to a capture-associated oligo, and allowing any target agents in the sample to bind to the contents of the chamber; B introducing the reacted capture-associated oligo complex to the second chamber, which contains a binding partner for isolation of the reacted capture-associated oligo complex; C isolating the reacted capture-associated oligo complex bound to the binding partner; D cleaving the capture moiety from the reacted capture-associated oligo complex to produce released capture-associated oligos; E introducing the released capture-associated oligos to a biosensor of the kit; and E allowing binding of the released capture-associated oligos to the complementary biosensor-associated oligos, effecting an electrochemical system that allows detection of the target agent.

FIG. 7 is a schematic diagram demonstrating a fifth method of using a kit of the present invention to detect a target agent using a binding partner for isolation of a reacted capture-associated oligo complex. The method of the kit comprises the following steps: A adding a sample suspected of containing one or more target agents from a specific subset of target agents to a vessel comprising a capture moiety conjugated to a capture-associated oligo; B adding a binding partner for isolation of the reacted capture-associated oligo complex; C isolating the reacted capture-associated oligo complex from the vessel; and D reacting the complex with the appropriate nucleotides and polymerase to provide creation of a nucleic acid molecule complementary to the capture-associated oligo. The reactions are carried out to create multiple copies of the complement to the capture-associated oligo via linear amplification. E. The newly synthesized capture-associated oligo complements are introduced to the electrode-associated oligos. F. The binding of the capture-associated oligo complements to the complementary electrode-associated oligos will effect an electrochemical system that allows detection of the target agent.

FIG. 8 is a schematic diagram demonstrating a sixth method of using a kit of the present invention to detect a target agent using a binding partner for isolation of a reacted capture-associated oligo complex. The method of the kit comprises the following steps: A adding a sample suspected of containing one or more target agents from a specific subset of target agents to the first chamber of a vessel comprising two or more chambers, where the first chamber contains a capture moiety conjugated to a capture-associated oligo and allowing any target agents in the sample to bind to the capture moiety to form a reacted capture-associated oligo complex; B introducing the reacted capture-associated oligo complex to the second chamber, which contains a binding partner for isolation of the reacted capture-associated oligo complex; C isolating the reacted capture-associated oligo complex from the vessel; and D reacting the reacted capture-associated oligo complex with the appropriate nucleotides and polymerase to provide creation of a nucleic acid molecule complementary to the capture-associated oligo. E The reactions are carried out to create multiple copies of the complement to the capture-associated oligo via linear amplification. F The newly synthesized capture-associated oligo complements are introduced to the electrode-associated oligos. G The binding of the capture-associated oligo complements to the complementary electrode-associated oligos will effect an electrochemical system that allows detection of the target agent.

FIG. 9 illustrates the structures of exemplary minor groove ligands for use in the present invention.

FIG. 10 illustrates the DNA binding of the minor groove ligands. FIG. 10A shows a 1:1 binding ratio of the minor groove ligand distamycin in the minor groove of a double-stranded DNA helix. FIG. 10B shows a 2:1 binging of distamycin in the minor groove, and a resulting widening of the minor groove compared to the 1:1 ratio binding.

### DEFINITIONS

The terms used herein are intended to have the plain and ordinary meaning as understood by those of ordinary skill in the art. The following definitions are intended to aid the reader in understanding the present invention, but are not intended to vary or otherwise limit the meaning of such terms unless specifically indicated. To the extent that the definitions presented in this specification differ from any definitions set forth implicitly or explicitly in any reference or priority document cited herein, it is to be understood that those presented herein are to be used in understanding the embodiments of the invention as set forth herein

The terms “nucleic acid molecules,” “oligonucleotides,” or “oligos” as used herein refer to oligomers of natural or modified nucleic acid monomers or linkages, including deoxyribonucleotides, ribonucleotides, anomeric forms thereof, peptide nucleic acid monomers (PNAs), locked nucleotide acid monomers (LNA), and the like, capable of specifically binding to a single-stranded polynucleotide by way of a regular pattern of monomer-to-monomer interactions, such as Watson-Crick type of base pairing, base stacking, Hoogsteen or reverse Hoogsteen types of base pairing, or the like. Usually monomers are linked by phosphodiester bonds or analogs thereof to form oligonucleotides ranging in size from a few monomeric units, e.g., 8-12, to several tens of monomeric units, e.g., 100-200. Suitable nucleic acid molecules may be prepared by the phosphoramidite method described by Beaucage and Carruthers (Tetrahedron Lett., 22, 1859-1862, 1981), or by the triester method according to Matteucci, et al. (J. Am. Chem. Soc., 103, 3185, 1981), both incorporated herein by reference, or by other chemical methods such as using a commercial automated oligonucleotide synthesizer. Typically, oligonucleotides are single-stranded, but double-stranded or partially double-stranded oligos may also be used in certain embodiments of the invention. The term “capture-associated oligo” refers to an oligo that is associated with a capture moiety (whether, e.g., conjugated to the capture moiety directly or via a loaded scaffold, for example). Conjugation to the capture moiety (or scaffold) may be at the 3′ or 5′ end of the capture-associated oligo. The term “biosensor-associated oligo” refers to an oligo that is associated with a biosensor (e.g., on an electrode). Association to the biosensor may occur at the 3′ or 5′ end, but typically occurs at the 5′ end.

The terms “complementary” and “complementarity” refer to oligonucleotides related by base-pairing rules. Complementary nucleotides are, generally, A and T (or A and U), or C and G. For example, for the sequence “5′-AGT-3′,” the perfectly complementary sequence is “3′-TCA-5′.” Methods for calculating the level of complementarity between two nucleic acids are widely known to those of ordinary skill in the art. For example, complementarity may be computed using online resources, such as, e.g., the NCBI BLAST website (ncbi.nlm.nih.gov/blast/producttable.shtml) and the Oligonucleotides Properties Calculator on the Northwestern University website (basic.northwestern.edu/biotools/oligocalc.html). Two single-stranded RNA or DNA molecules may be considered substantially complementary when the nucleotides of one strand, optimally aligned and with appropriate nucleotide insertions or deletions, pair with at least about 80% of the nucleotides of the other strand, usually at least about 90% to 95%, and more preferably from about 98 to 100%. Two single-stranded oligonucleotides are considered perfectly complementary when the nucleotides of one strand, optimally aligned and with appropriate nucleotide insertions or deletions, pair with 100% of the nucleotides of the other strand. Alternatively, substantial complementarity exists when a first oligonucleotide will hybridize under selective hybridization conditions to a second oligonucleotide. Selective hybridization conditions include, but are not limited to, stringent hybridization conditions. Selective hybridization occurs in one embodiment when at least about 65% of the nucleic acid monomers within a first oligonucleotide over a stretch of at least 14 to 25 monomers pair with a perfectly complementary monomer within a second oligonucleotide, preferably at least about 75%, more preferably at least about 90%. See, M. Kanehisa, Nucleic Acids Res. 12, 203 (1984), incorporated herein by reference. For shorter nucleotide sequences selective hybridization occurs when at least about 65% of the nucleic acid monomers within a first oligonucleotide over a stretch of at least 8 to 12 nucleotides pair with a perfectly complementary monomer within a second oligonucleotide, preferably at least about 75%, more preferably at least about 90%. Stringent hybridization conditions will typically include salt concentrations of less than about 1 M, more usually less than about 500 mM and preferably less than about 200 mM. Hybridization temperatures can be as low as 5° C., and are preferably lower than about 30° C. However, longer fragments may require higher hybridization temperatures for specific hybridization. Hybridization temperatures are generally at least about 2° C. to 6° C. lower than melting temperatures (Tₘ), which are defined below.

The phrase “binding region of an oligo” refers to the area of an oligo that is designed to specifically hybridize to its complementary oligo, e.g., the binding region of a capture-associated oligo is the region that binds to the biosensor-associated oligo, or the region that is directly complementary to this region.

As used herein “nucleotide” refers to a base-sugar-phosphate combination. Nucleotides are monomeric units of a nucleic acid sequence (DNA and RNA). The term nucleotide includes ribonucleoside triphosphates ATP, UTP, CTG, GTP and deoxyribonucleoside triphosphates such as dATP, dCTP, dITP, dUTP, dGTP, dTTP, or derivatives thereof. Such derivatives include, for example, [αS]dATP, 7-deaza-dGTP and 7-deaza-dATP, and nucleotide derivatives that confer nuclease resistance on the nucleic acid molecule containing them. The term nucleotide as used herein also refers to dideoxyribonucleoside triphosphates (ddNTPs) and their derivatives. Illustrated examples of dideoxyribonucleoside triphosphates include, but are not limited to, ddATP, ddCTP, ddGTP, ddITP, and ddTTP. According to the present invention, a “nucleotide” may be unlabeled or detectably labeled by well known techniques. Detectable labels include, for example, radioactive isotopes, fluorescent labels, chemiluminescent labels, bioluminescent labels and enzyme labels. Fluorescent labels of nucleotides may include, but are not limited to, fluorescein, 5-carboxyfluorescein (FAM), 2′,7′-dimethoxy-4′,5-dichloro-6-carboxyfluorescein (JOE), rhodamine, 6-carboxyrhodamine (R6G), N,N,N′,N′-tetramethyl-6-carboxyrhodamine (TAMRA), 6-carboxy-X-rhodamine (ROX), 4-(4′dimethylaminophenylazo) benzoic acid (DABCYL), Cascade Blue, Oregon Green, Texas Red, Cyanine and 5-(2′-aminoethyl)aminonaphthalene-1-sulfonic acid (EDANS). Specific examples of fluorescently labeled nucleotides include [R6G]dUTP, [TAMRA]dUTP, [R110]dCTP, [R6G]dCTP, [TAMRA]dCTP, [JOE]ddATP, [R6G]ddATP, [FAM]ddCTP, [R110]ddCTP, [TAMRA]ddGTP, [ROX]ddTTP, [dR6G]ddATP, [dR110]ddCTP, [dTAMRA]ddGTP, and [dROX]ddTTP, available from Perkin Elmer, Foster City, Calif. FluoroLink DeoxyNucleotides, FluoroLink Cy3-dCTP, FluoroLink Cy5-dCTP, FluoroLink FluorX-dCTP, FluoroLink Cy3-dUTP, and FluoroLink Cy5-dUTP available from Amersham Arlington Heights, Ill.; Fluorescein-15-dATP, Fluorescein-12-dUTP, Tetramethyl-rodamine-6-dUTP, IR₇₇₀₋₉-dATP, Fluorescein-12-ddUTP, Fluorescein-12-UTP, and Fluorescein-15-2′-dATP available from Boehringer Mannheim Indianapolis, Ind.; and ChromaTide Labeled Nucleotides, BODIPY-FL-14-UTP, BODIPY-FL-4-UTP, BODIPY-TMR-14-UTP, BODIPY-TMR-14-dUTP, BODIPY-TR-14-UTP, BODIPY-TR-14-dUTP, Cascade Blue-7-UTP, Cascade Blue-7-dUTP, fluorescein-12-UTP, fluorescein-12-dUTP, Oregon Green 488-5-dUTP, Rhodamine Green-5-UTP, Rhodamine Green-5-dUTP, tetramethylrhodamine-6-UTP, tetramethylrhodamine-6-dUTP, Texas Red-5-UTP, Texas Red-5-dUTP, and Texas Red-12-dUTP available from Molecular Probes, Eugene, Oreg.

A “capture moiety” refers to a molecule or a portion of a molecule that can be used to preferentially bind and separate a molecule of interest (a “target agent”) from a sample. The term “capture moiety” as used herein refers to any molecule, natural, synthetic, or recombinantly-produced, or portion thereof, with the ability to bind to or otherwise associate with a target agent in a manner that facilitates detection of the target agent in the methods of the present invention. For example, in certain embodiments the binding affinity of the capture moiety is sufficient to allow collection, concentration, or separation of the target agent from a sample. Suitable capture moieties include, but are not limited to nucleic acids, antibodies, antigen-binding regions of antibodies, antigens, epitopes, cell receptors (e.g., cell surface receptors) and ligands thereof, such as peptide growth factors (see, e.g., Pigott and Power (1993), The Adhesion Molecule Facts Book (Academic Press New York); and Receptor Ligand Interactions: A Practical Approach, Rickwood and Hames (series editors) Hulme (ed.) (IRL Press at Oxford Press NY)). Similarly capture moieties may also include but are not limited to toxins, venoms, intracellular receptors (e.g., receptors which mediate the effects of various small ligands, including steroids, hormones, retinoids and vitamin D, peptides) and ligands thereof, drugs (e.g., opiates, steroids, etc.), lectins, sugars, oligosaccharides, other proteins, phospholipids, and structured nucleic acids such as aptamers and the like. Those of skill in the art readily will appreciate that molecular interactions other than those listed above are well described in the literature and may also serve as capture moiety/target agent interactions. For example, if a capture moiety is an antibody specific for a particular infectious agent (such as a bacterial or viral agent), an immobilized binding partner can be a naturally-occurring or synthetic epitope of the antigen with which the antibody recognizes and interacts in a specific manner. In another example, if a capture moiety is an antigen specific for a particular antibody, an immobilized binding partner can be a naturally-occurring or synthetic antibody or functional fragment thereof with which the antigen recognizes and interacts in a specific manner. Capture moieties that have bound target agent may be referred to as “reacted capture moieties,” and capture moieties that have not bound target agent may be referred to as “unreacted capture moieties.” In certain embodiments, capture moieties are conjugated to capture-associated oligos. If multiple capture-associated oligo complexes are used, each having a capture moiety specific for a different target agent or different epitope of the same target agent, multiple immobilized binding partners can be used to facilitate the separation of the reacted capture-associated oligo complexes (bound to target agent) from unreacted capture-associated oligo complexes (those with capture moieties that did not react with target agent in the sample). In such a detection method, multiple different target agents (e.g., agents specific to different viruses and/or bacteria) may be detected simultaneously.

The term “binding partner” as used herein refers to any molecule, natural, synthetic, or recombinantly-produced, with the ability to bind to a target agent and/or capture moiety in the methods of the present invention. For example, in some embodiments a “binding partner” is a molecule or portion thereof that preferentially binds to a moiety of the target agent different from a moiety of the target agent that is bound by a capture moiety, such that both the capture moiety and the binding partner may be simultaneously bound to the target agent. In other embodiments, a “binding partner” may preferentially bind to a capture moiety/target agent complex. Alternatively, in certain embodiments immobilized binding partners will bind unreacted capture moieties (i.e., those that have not bound to target agent). The binding affinity of the binding partner must be sufficient to allow collection of the target agent and/or capture moiety from a sample and/or sample mixture. Suitable binding moieties include, but are not limited to, antibodies, antigen-binding regions of antibodies, antigens, epitopes, cell receptor ligands, such as peptide growth factors (see, e.g., Pigott and Power (1993), The Adhesion Molecule Facts Book (Academic Press New York); and Receptor Ligand Interactions: A Practical Approach, Rickwood and Hames (series editors) Hulme (ed.) (IRL Press at Oxford Press NY)). Similarly, binding partners may also include but are not limited to toxins, venoms, intracellular receptors (e.g., receptors which mediate the effects of various small ligands, including steroids, hormones, retinoids and vitamin D, peptides), drugs (e.g., opiates, steroids, etc.), lectins, sugars, oligosaccharides, other proteins, and phospholipids. Those of skill in the art readily will appreciate that a number of binding partners based upon molecular interactions other than those listed above are well described in the literature and may also serve as binding partners. The binding partners can be affixed/immobilized directly or indirectly to a matrix such as a vessel wall, to particles or beads (as described in more detail infra), or to other suitable surfaces to form “immobilized binding partners.” Those of skill in the art will readily understand the versatility of the nature of this immobilized binding partner. Essentially, any ligand and receptor can be utilized to serve as capture moieties, target agents and binding partners, as long as the target agent is appropriate for detection for the pathology or condition interrogated. Suitable ligands and receptors include an antibody or fragment thereof to be recognized by a corresponding antigen or epitope, a hormone to be recognized by its receptor, an inhibitor to be recognized by its enzyme, a co-factor portion to be recognized by a co-factor enzyme binding site, a binding ligand to be recognized by its substrate, and the like.

By “preferentially binds” it is meant that a specific binding event between a first and second molecule occurs at least 20 times or more, preferably 50 times or more, more preferably 100 times or more, and even 1000 times or more often than a nonspecific binding event between the first molecule and a molecule that is not the second molecule. For example, a capture moiety can be designed to preferentially bind to a given target agent at least 20 times or more, preferably 50 times or more, more preferably 100 times or more, and even 1000 times or more often than to other molecules in a biological solution. Also, an immobilized binding partner, in certain embodiments, will preferentially bind to a target agent, capture moiety, or capture moiety/target agent complex. While not wishing to be limited by applicants present understanding of the invention, it is believed binding will be recognized as existing when the Kₐ is at 10⁷ l/mole or greater, preferably 10⁸ l/mole or greater. In the embodiment where the capture moiety is comprised of antibody, the binding affinity of 10⁷ l/mole or more may be due to (1) a single monoclonal antibody (e.g., large numbers of one kind of antibody) or (2) a plurality of different monoclonal antibodies (e.g., large numbers of each of several different monoclonal antibodies) or (3) large numbers of polyclonal antibodies. It is also possible to use combinations of (1)-(3). The differential in binding affinity may be accomplished by using several different antibodies as per (1)-(3) above and as such some of the antibodies in a mixture could have less than a four-fold difference. For purposes of most embodiments of the invention an indication that no binding occurs means that the equilibrium or affinity constant Kₐ is 10⁶ l/mole or less. Antibodies may be designed to maximize binding to the intended antigen by designing peptides to specific epitopes that are more accessible to binding, as can be predicted by one skilled in the art.

A “target agent” is a molecule of interest in a sample that is to be detected by the methods of the instant invention. For example, in certain embodiments the target agent is captured through preferential binding with a capture moiety. In one such embodiment, the capture moiety is an antibody and the target agent is any molecule which contains an epitope against which the antibody is generated, or an epitope specifically bound by the antibody. In another embodiment, the capture moiety is a protein specifically bound by an antibody, and the antibody itself is the target agent. Target agents also may include but are not limited to receptors (e.g., cell surface receptors) and ligands thereof, nucleic acids, intracellular receptors (e.g., receptors which mediate the effects of various small ligands, including steroids, hormones, retinoids and vitamin D, peptides) and ligands thereof, metabolites, steroids, hormones, lectins, sugars, oligosaccharides, proteins, phospholipids, toxins, venoms, drugs (e.g., opiates, steroids, etc.), and the like. Those of skill in the art readily will appreciate that molecular interactions other than those listed above are well described in the literature and may also serve as capture moiety/target agent interactions. In certain embodiments, the target agents to be detected are suspected of causing or capable of causing a pathological or otherwise observable or detectable condition in humans or animals. For example, the target agents can include, but are not limited to, bacteria, viruses, proteinacious agents (such as prions), metabolites, biological agents and/or chemical agents. Again, those of skill in the art would appreciate and understand the particular type of target agent to be found in a particular sample and that is suspected of being related to a particular physiological condition or state. Other target agents that can be detected include air-borne, food-borne and water-borne agents, including biological and chemical toxins. The only requirement on the particular target agent to be detected is the presence of a capture moiety specific for that target agent.

The term “sample” in the present specification and claims is used in its broadest sense and can be, by non-limiting example, any sample that is suspected of containing a target agent(s) to be detected. It is meant to include specimens or cultures (e.g., microbiological cultures), and biological and environmental specimens as well as non-biological specimens. Biological samples may comprise animal-derived materials, including fluid (e.g., blood, saliva, urine, lymph, etc.), solid (e.g., stool) or tissue (e.g., buccal, organ-specific, skin, etc.), as well as liquid and solid food and feed products and ingredients such as dairy items, vegetables, meat and meat by-products, and waste. Biological samples may be obtained from, e.g., humans, any domestic or wild animals, plants, bacteria or other microorganisms, etc. Environmental samples can include environmental material such as surface matter, soil, water (e.g., contaminated water), air and industrial samples, as well as samples obtained from food and dairy processing instruments, apparatus, equipment, utensils, disposable and non-disposable items. These examples are not to be construed as limiting the sample types applicable to the present invention. Those of skill in the art would appreciate and understand the particular type of sample required for the detection of particular target agents (Pawliszyn, J., Sampling and Sample Preparation for Field and Laboratory, (2002); Venkatesh Iyengar, G., et al., Element Analysis of Biological Samples: Principles and Practices (1998); Drielak, S., Hot Zone Forensics: Chemical, Biological, and Radiological Evidence Collection (2004); and Nielsen, D. M., Practical Handbook of Environmental Site Characterization and Ground-Water Monitoring (2005)).

The term “antibody” as used herein refers to an entire immunoglobulin or antibody or any fragment of an immunoglobulin molecule which is capable of specific binding to a target agent of interest (an antigen). Examples of such antibodies include complete antibody molecules, antibody fragments, such as Fab, F(ab′)₂, CDRS, V_{L}, V_{H}, and any other portion of an antibody which is capable of specifically binding to an antigen. An IgG antibody molecule is composed of two light chains linked by disulfide bonds to two heavy chains. The two heavy chains are, in turn, linked to one another by disulfide bonds in an area known as the hinge region of the antibody. A single IgG molecule typically has a molecular weight of approximately 150-160 kD and contains two antigen binding sites. An F(ab′)₂ fragment lacks the C-terminal portion of the heavy chain constant region, and has a molecular weight of approximately 110 kD. It retains the two antigen binding sites and the interchain disulfide bonds in the hinge region, but it does not have the effector functions of an intact IgG molecule. An F(ab′)₂ fragment may be obtained from an IgG molecule by proteolytic digestion with pepsin at pH 3.0-3.5 using standard methods such as those described in Harlow and Lane, supra. Preferred antibodies for assays of the invention are immunoreactive or immunospecific for, and therefore specifically and selectively bind to, a protein (antigen) of interest and are not limited to the G class of immunoglobulin used in the above cited example. A “purified antibody” refers to that which is sufficiently free of other proteins, carbohydrates, and lipids with which it is naturally associated to measure any difference.

A substance is commonly said to be present in “excess” or “molar excess” relative to another component if that component is present at a higher molar concentration than the other component. Often, when present in excess, the component will be present in at least a 10-fold molar excess and commonly at 100-1,000,000 fold molar excess. Those of skill in the art would appreciate and understand the particular degree or amount of excess preferred for any particular reaction or reaction conditions. Such excess is often empirically determined and/or optimized for a particular reaction or reaction conditions.

The term “reacted capture-associated oligo” is commonly used in reference to capture-associated oligos associated with a capture moiety for a particular target agent, where the capture moiety has bound to the target agent, e.g., due to the presence of the target agent in a sample contacted with the capture moiety. The term “unreacted capture-associated oligo” is used in reference to capture-associated oligos associated with a capture moiety for a particular target agent, where the capture moiety has not bound to the target agent, e.g., due to a deficiency of the target agent in a sample contacted with the capture moiety.

The term “capture reaction” is commonly used in reference to the mixing/contacting of capture-associated oligos associated with a capture moiety and a sample under conditions that allow the capture moiety to attach to, bind or otherwise associate with a target agent in the sample.

The term “melting temperature” or Tₘ is commonly defined as the temperature at which half of the population of double-stranded nucleic acid molecules becomes dissociated into single strands. The equation for calculating the Tₘ of nucleic acids is well known in the art. As indicated by standard references, a simple estimate of the Tₘ value may be calculated by the equation: Tₘ=81.5+16.6(log₁₀[Na⁺])0.41(%[G+C])−675/n−1.0 m, when a nucleic acid is in aqueous solution having cation concentrations of 0.5 M, or less, the (G+C) content is between 30% and 70%, n is the number of bases, and m is the percentage of base pair mismatches (see e.g., Sambrook J et al., “Molecular Cloning, A Laboratory Manual,” 3^{rd} Edition, Cold Spring Harbor Laboratory Press (2001)). Other references include more sophisticated computations, which take structural as well as sequence characteristics into account for the calculation of Tₘ.

The term “matrix” means any solid surface.

A “restriction endonuclease” is any enzyme capable of recognizing a specific sequence on a double- or single-stranded polynucleotide and cleaving the polynucleotide at or near the site. Examples of site-specific restriction endonucleases, the nucleotide sequences recognized by them, and their products of cleavage are well known to those of ordinary skill in the art and are available, e.g., in the 2006 New England Biolabs, Inc. catalog, including the 2006 New Products Catalog Supplement, which is incorporated herein by reference.

An “epitope” as used herein refers to any portion of a molecule that is capable of preferentially binding to a capture moiety, a binding partner, or a target agent. For example, an epitope can be a site on an antigen that is recognized by an antibody or a region of a protein that is recognized by a receptor.

A “detection moiety” is any one or a plurality of chemical moieties capable of enabling the molecular recognition on a biosensor (e.g., an electrochemical hybridization detector). In certain embodiments, the detection moiety can be any chemical moiety that is stable under assay conditions and can undergo reduction and/or oxidation. Examples of such detection moieties include, but are not limited to, purely organic labels, such as viologen, anthraquinone, ethidium bromide, daunomycin, methylene blue, and their derivatives, organo-metallic labels, such as ferrocene, ruthenium, bis-pyridine, tris-pyridine, bis-imidizole, and their derivatives, and biological labels, such as cytochrome c, plastocyanin, and cytochrome c′. Specific electroactive agents for use in the invention include a large number of ferrocene (Brazill, S. A., Kim, P. H. & Kuhr, W. G., Anal. Chem. 73, 4882-4890 (2001)) and viologen derivatives (Fan, C., Hirasa, T., Plaxco, K. W. and Heeger, A. J. (2003)) and any other stable agent capable of oxidation-reduction reactions. In specific embodiments, the detection moiety is comprised of a plurality of electrochemical hybridization detectors (e.g., ferrocene), optionally linked to a hydrocarbon molecule. Such molecules include but are not limited to ferrocene-hydrocarbon mixtures; such as ferrocene-methane, ferrocene-acetylene, and ferrocene-butane. In one particular embodiment, the detection moiety is Fe(CN)63-/4-. Further examples of methods using electrochemical hybridization detectors are provided herein. In yet other embodiments, the detection moiety is a fluorescent label moiety. The fluorescent label may be selected from any of a number of different moieties. The preferred moiety is a fluorescent group for which detection is quite sensitive. Various different fluorescence labels techniques are described, for example, in Cambara et al. (1988) “Optimization of Parameters in a DNA Sequenator Using Fluorescence Detection,” Bio/Technol. 6:816 821; Smith et al. (1985) Nucl. Acids Res. 13:2399 2412; and Smith et al. (1986) Nature 321:674 679, each of which is hereby incorporated herein by reference. Fluorescent labels exhibiting particularly high coefficients of destruction may also be useful in destroying nonspecific background signals. In yet other embodiments, the detection moiety is a detection antibody reagent, where the antibody is labeled with a molecular entity which allows detection of nucleic acid binding. Examples of such reagents include, but are not limited to, antibody reagents that preferentially bind to RNA:DNA complexes.

It should be understood by those skilled in the art that terms such as “target,” “agent,” “moiety,” “antigen,” “antibody,” “molecule,” and the like should be interpreted in the context in which they appear, and should be given the broadest interpretation possible unless specifically indicated.

### Devices of the Invention

The devices of the invention are constructed to allow the reactions needed for detection of a target agent in a sample to take place in a single container. This will minimize the waste associated with multiple container use, maintain sterility where this is an issue (such as for certain diagnostic uses or when a potentially pathogenic agent is the target agent) and will minimize user error. The devices of the invention comprise at least two reaction chambers which are connected in a manner to allow sequential, separate binding reactions to occur. In certain embodiments, the first reaction chamber contains a plurality of capture-associated oligo/capture moiety complexes, each capture moiety therein having the ability to specifically bind to a single target agent of the subset of target agents that may be present in a sample. The first reaction chamber is designed to hold aqueous contents within the chamber, including the capture moieties, buffers, and extractions from any samples to be tested for a period sufficient to allow an efficient binding reaction between the capture moieties of the first chamber and any target agent within the sample.

Following this reaction, the device is designed to allow contact of the contents of the first reaction chamber with a second reaction chamber. The contact may be allowed by any means known to those in the art. The chambers of the single vessel can be sealed until the exposure of the contents of the first chamber to the second chamber is desired. Such vessels having multiple chambers are well known in the art, and methods for providing such are described in U.S. Pat. Nos. 6,571,540, 6,454,130, http://patft1.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F6003702-h0#h0http://patft1.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F6003702-h2#h26,003,702, each of which are hereby expressly incorporated by reference. For example, when the two chambers of the container are separated by an impermeable membrane, puncture of the membrane between the two chambers will allow the solution in the first chamber to enter the second chamber. In another example, the two chambers may be separated by a sintered glass barrier that can be removed following the completion of the first binding reaction.

In one aspect of the invention, the second reaction chamber of the device comprises an excess of binding partners (e.g., each of the subset of target agents) immobilized on a solid surface within the second chamber. The solid surface to which the binding partners are immobilized may be any solid surface that can be retained within the chamber following removal of any liquid contents of the chamber, e.g., a matrix within the chamber, beads of a sufficient size for retention in the chamber, or may be the surface of the chamber itself, as described in more detail below. In a second aspect of the invention, the second reaction chamber of the device comprises a plurality of binding partners which will bind to either the target agent or to an epitope formed by the binding of the target agent to a capture moiety. The binding partner is conjugated to a solid surface to allow capture of the reacted capture-associated oligo complex, thus isolating the reacted capture-associated oligo complex for detection using the methods described herein.

In a specific aspect of the embodiment, the device is a column device with a removable plunger. Such devices that can be modified for use in the present invention include those described in U.S. Pat. Nos. 6,923,908; 6,811,688; http://patft.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F6527951-h0#h0http://patft.uspto.gov/netacgi/nph-Parser?Sect2=PTO1&Sect2=HITOFF&p=1&u=%2Fnetahtml%25%2FPTO %25%2Fsearch-bool.html&r=1&f=G&1=50&d=PALL&RefSrch=yes&Query=PN%2F6527951-h2#h26,527,951; http://patft.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F6224760-h0#h0http:patft.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F6224760-h2#h26,224,760; http://patft.uspto.gov/netacgi/nph-Parser?Sect2=PTO1&Sect2=HITOFF&p=1&u=%2 Fnetahtml%25%2FPTO%25%2Fsearch-bool.html&r=1&f=G&1=50&d=PALL&RefSrch=yes&Query=PN%2F5595653-h0#h0http://patft.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Ouery=PN%2F5595653-h2#h25,595,653; and http://patft.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F4891133-h0#h0http://patft.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F4891133-h2#h24,891,133, all of which are hereby expressly incorporated by reference.

In another device, the separate reactions are actually carried out in two containers that comprise a connector through which the contents of the first reaction can be transferred to the second reaction tube. In a case where two containers are used, the contents may be transferred from the first container to the second container via a connector such as that described in U.S. Pat. No. 6,910,720, http://patft1.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F6237649-h0#h0http://patft1.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F6237649-h2#h26,237,649, and http://patft1.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Query=PN%2F6213994-h0#h0http://patft1.uspto.gov/netacgi/nph-Parser?Sect2=PTO1&Sect2=HITOFF&p=1&u=%2Fnetahtml%25%2FPTO%25%2Fsearch-bool.html&r=1&f=G&1=50&d=PALL&RefSrch=yes&Ouery=PN%2F6213994-h2#h26,213,994, all of which are hereby expressly incorporated by reference.

### Isolation of Reacted Capture Moieties

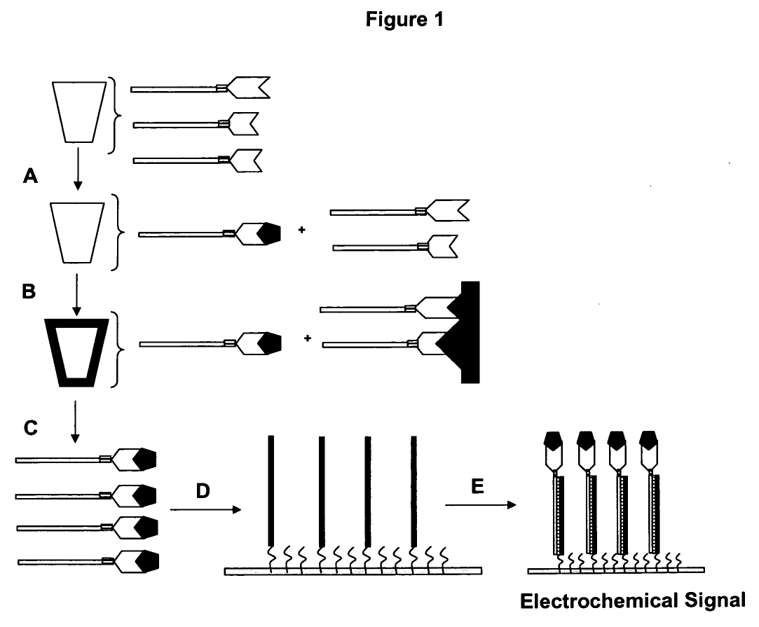

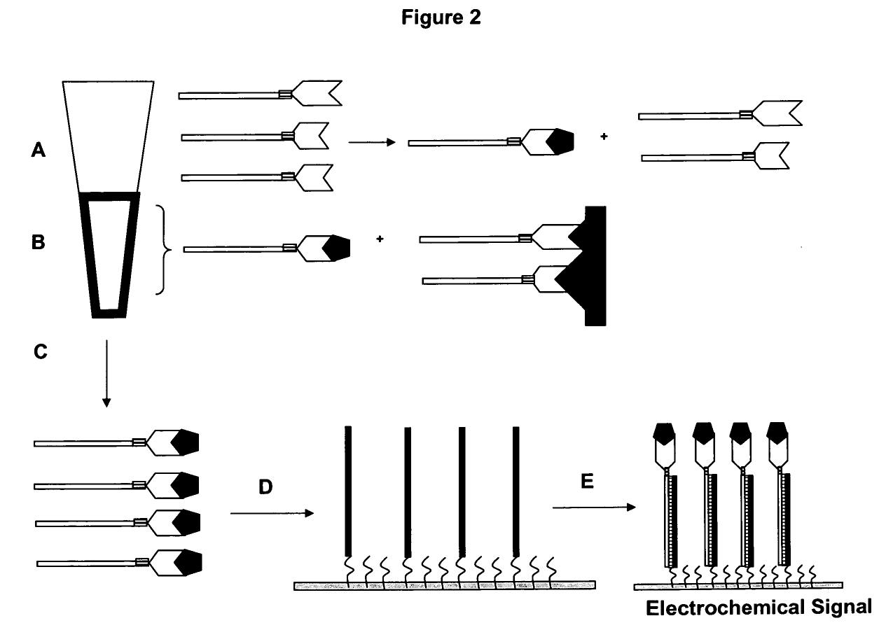

In certain embodiments of the present invention, summarized as FIGS. 1 and 2, the reacted capture-associated oligo complex (i.e., a capture-associated oligo/capture moiety complex that has bound to target agent) is isolated from the unreacted capture-associated oligo complexes (i.e., capture-associated oligo/capture moiety complexes that have not bound to target agent) using a binding depletion step. The depletion is achieved using an excess of binding partners (e.g., target agents) associated with a solid substrate, such as a matrix or a bead.

In various embodiments, the binding partners are bound to a matrix that is a vessel wall or floor. Alternatively, the matrix may be macroscopic particles, such as Sephadex®, which may be used to construct a column with a filter, over which the mixture of reacted and unreacted capture-associated oligo complexes can be passed. Similarly, the matrix may include a suspension of particulate matter in a solution, such as microscopic and/or macroscopic beads, where the binding partners are immobilized on the beads or particle. In a method using particles, the unreacted capture-associated oligo complexes will be retained on the semi-solid support created by the particles, whereas the reacted capture-associated oligo complexes will be eluted through the semi-solid support. Thus, only those capture-associated oligos in complexes with target agent from the sample will be available for hybridization and detection.

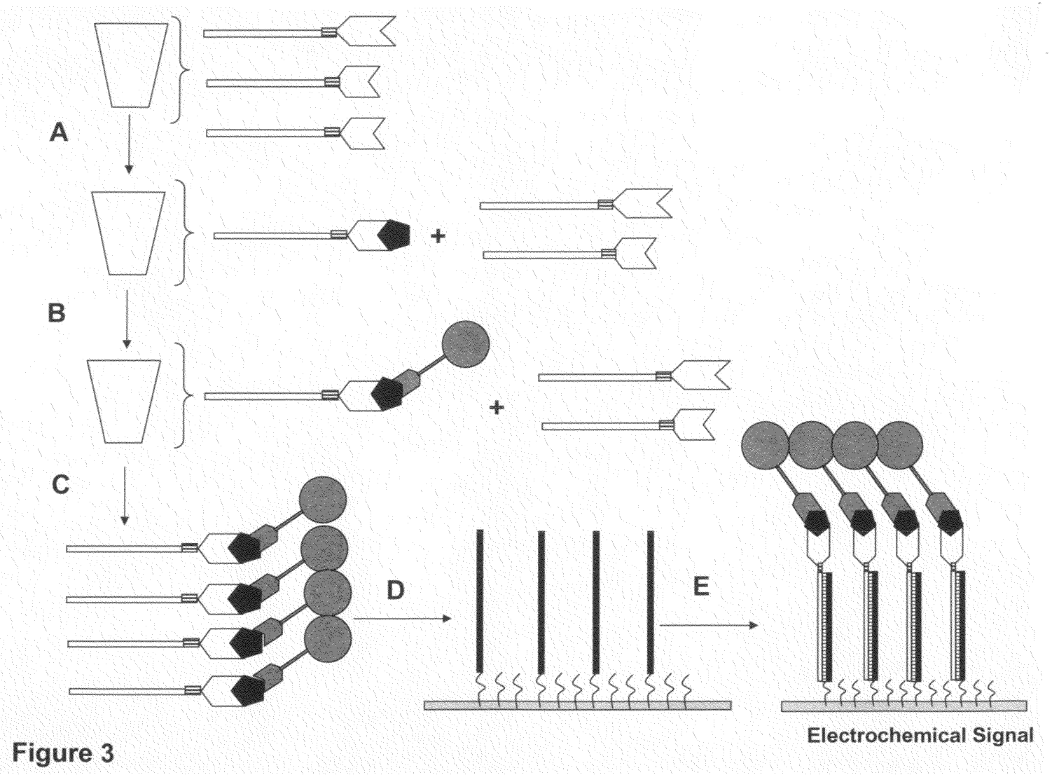

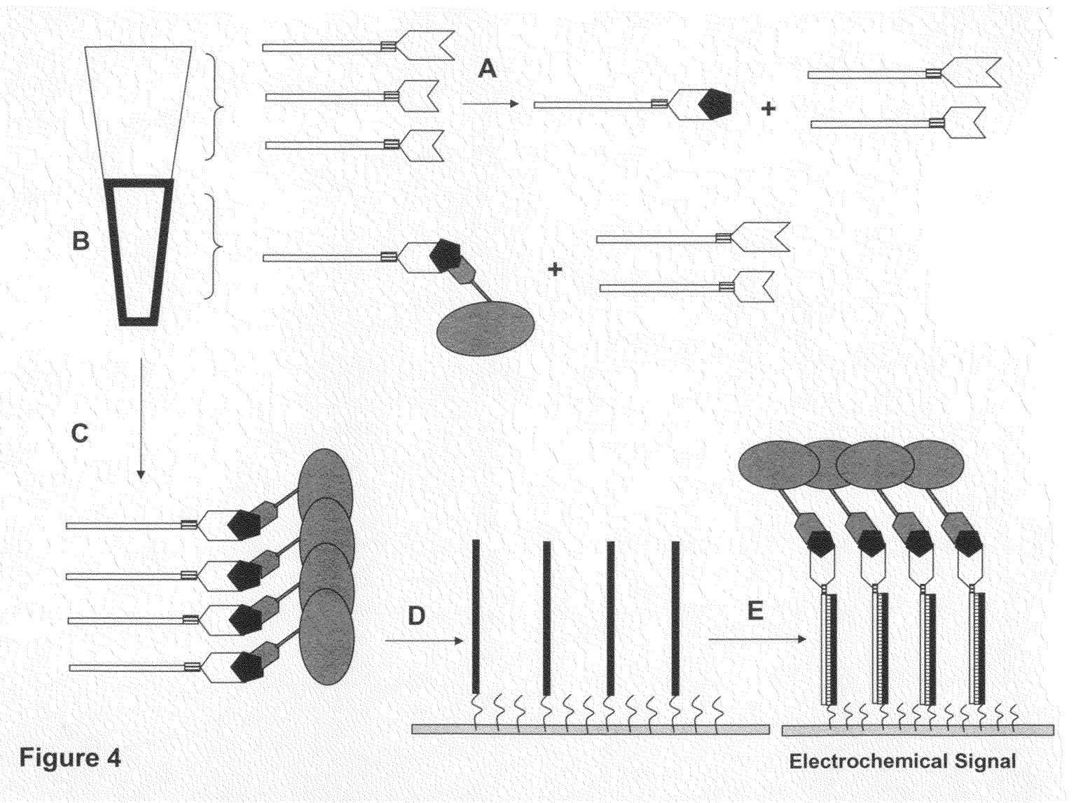

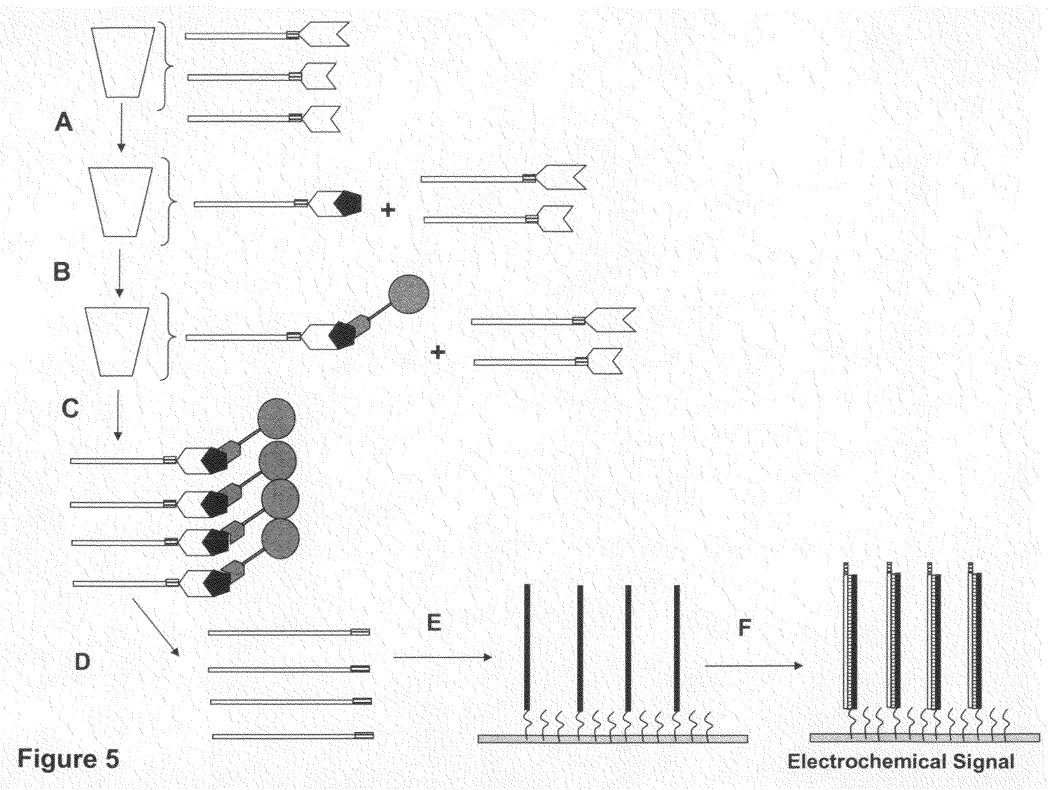

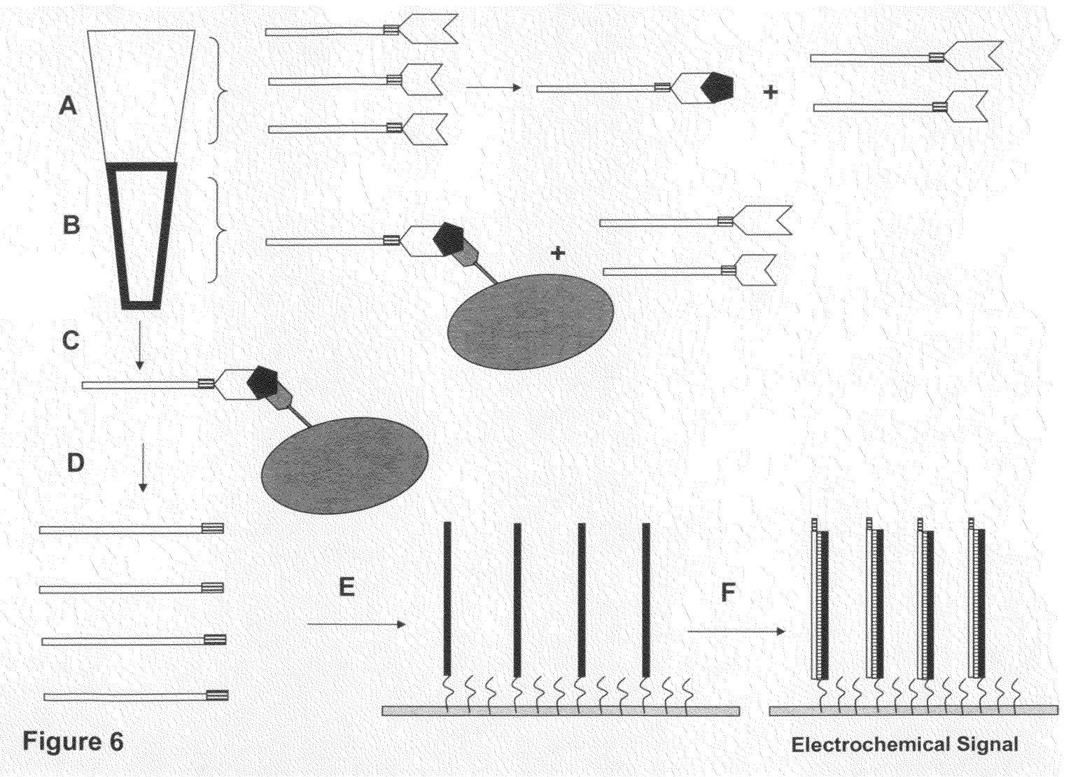

In other specific embodiments, summarized as schematic diagrams in FIGS. 3-6, the reacted capture-associated oligo complex is isolated from the unreacted capture-associated oligo complexes by exposing the mixture comprising both to a binding partner which recognizes an epitope on the target agent different from that of the capture moiety. The binding partners may be directly or indirectly coupled to a solid substrate that will allow isolation of the reacted capture-associated oligo complex. Exemplary solid substrates for use in the separation step are magnetic beads or other binding moieties (avidin or strepavidin) that allow isolation through their binding affinity to a separate molecule. Reacted capture-associated oligo complexes that bind to the binding partner can be isolated using known techniques including, but not limited to, centrifugation, size exclusion chromatography, filtration, magnetism and the like. In certain embodiments of the invention, the capture-associated oligo within the retained, reacted capture-associated oligo complex can be selectively released by known methods including, but not limited to, the cleavage step, discussed in detail below. For example, antibodies specific for the target agent may be chemically bound to the surface of magnetic particles for example, using cyanogen bromide. When the magnetic particles are reacted with a sample, conjugates will form between antibody bound to the magnetic particles and the target agents, e.g., via an available epitope of the target agent bound to a capture-associated oligo complex. In a specific embodiment, the binding partner is conjugated to a solid substrate (e.g., a bead) that will allow isolation of the reacted capture-associated oligo complex based on the mass of the solid substrate, e.g., isolation of the beads through the use of density centrifugation. This will allow rapid isolation without the need for specialized equipment.

When employing suspensions of particulate matter in a solution, reacted capture-associated oligo complexes can be isolated from unreacted capture-associated oligo complexes using techniques such as centrifugation, size exclusion chromatography, filtration and the like. In a method using beads, in particular magnetic beads, the separation step can be achieved by applying a magnetic field to the magnetic beads. In some embodiments, the beads will bind to the unreacted capture-associated oligo complexes, leaving the reacted capture-associated oligo complexes in solution and available for hybridization. In other embodiments, the beads will bind with the reacted capture-associated oligo complexes, leaving the unreacted capture-associated oligo complexes in solution.

In one particular embodiment of the invention, bispecific antibodies are used to conjugate the target agent to the matrix. Bispecific antibodies contain a variable region of an antibody that can bind to the unreacted capture-associated oligo complexes and a variable region specific for at least one antigen on the surface of a matrix. The bispecific antibodies may be prepared by forming hybrid hybridomas. The hybrid hybridomas may be prepared using the procedures known in the art such as those disclosed in Staerz & Bevan, (1986, PNAS (USA) 83:1453) and Staerz & Bevan, (1986, Immunology Today, 7:241). Bispecific antibodies may also be constructed by chemical means using procedures such as those described by Staerz et al., (1985, Nature, 314:628) and Perez et al., (1985 Nature 316:354), or by expression of recombinant immunoglobulin gene constructs.

### Biosensors for Use in the Kits of the Invention

In certain embodiments, the biosensor comprises a detection chamber and an electrode that are part of a cartridge that can be placed into a device comprising electronic components selected from the group comprising potentiometers, AC/DC voltage source, ammeters, processors, displays, temperature controllers, light sources, and the like. In a typical embodiment, the interconnections from each electrode are positioned such that upon insertion of the cartridge into the device, connections between the electrodes and the electronic components are established. The device can also comprise a means for controlling the temperature, such as a peltier block, that facilitates the conditions employed in the hybridization reaction.

In certain preferred embodiments, an electrode is first coated with a biocompatible substance (such as dextran, carboxylmethyldextran, other hydrogels, polypeptides, polynucleotides, biocompatible and/or bio-inert matrices or the like). The electrode-associated nucleic acid is immobilized to such biocompatible substance.

The biosensor-associated oligos may be immobilized onto the electrodes directly or indirectly by covalent bonding, ionic bonding and physical adsorption. Examples of immobilization by covalent bonding include a method in which the surface of the electrode is activated and the oligo is then immobilized directly to the electrode or indirectly through a cross linking agent. Yet another method using covalent bonding to immobilize a biosensor-associated oligo includes introducing an active functional group into an oligonucleotide followed by direct or indirect immobilization. The activation of the surface may be conducted by electrolytic oxidation in the presence of an oxidizing agent, or by air oxidation or reagent oxidation, as well as by covering with a film. Useful cross-linking agents include, but are not limited to, silane couplers such as cyanogen bromide and gamma-aminopropyl triethoxy silane, carbodiimide and thionyl chloride and the like. Useful functional groups to be introduced to the oligo may be, but are not limited to, sulfide, disulfide, amino, amide, amido, a carboxyl, a hydroxyl, carbonyl, oxide, phosphate, sulfate, aldehyde, keto, ester and mercapto groups. Other highly reactive functional groups may also be employed using methods readily known to those of ordinary skill in the art.

To detect multiple target agents in a sample, multiple electrodes, or an electrode with multiple biosensor-associated oligos attached in a predetermined configuration are employed. In some such configurations, a plurality of electrodes each having a distinct electrode-associated oligo affixed thereto or otherwise associated therewith arranged in predetermined configuration. In a preferred embodiment, the voltage applied to each electrode is equal. Additionally, to verify the hybridization of a particular biosensor-associated oligo, the electrochemical detection device preferably includes a switch circuit, a decoder circuit, and/or, a timing circuit to apply the voltage to the individual electrodes and to receive the output signal from each of the electrodes.

### Sensitization of Detection Using Linear Amplification

In certain embodiments, it may be beneficial to use amplification to increase the number of oligos available for binding to the biosensor-associated oligos (e.g., electrode-associated oligos), thus enhancing the signal created through complementary binding. The linear amplification methods using the capture-associated oligo as a template can be combined with any of the described kits and methods of the invention, including those utilizing the specific devices as described herein.

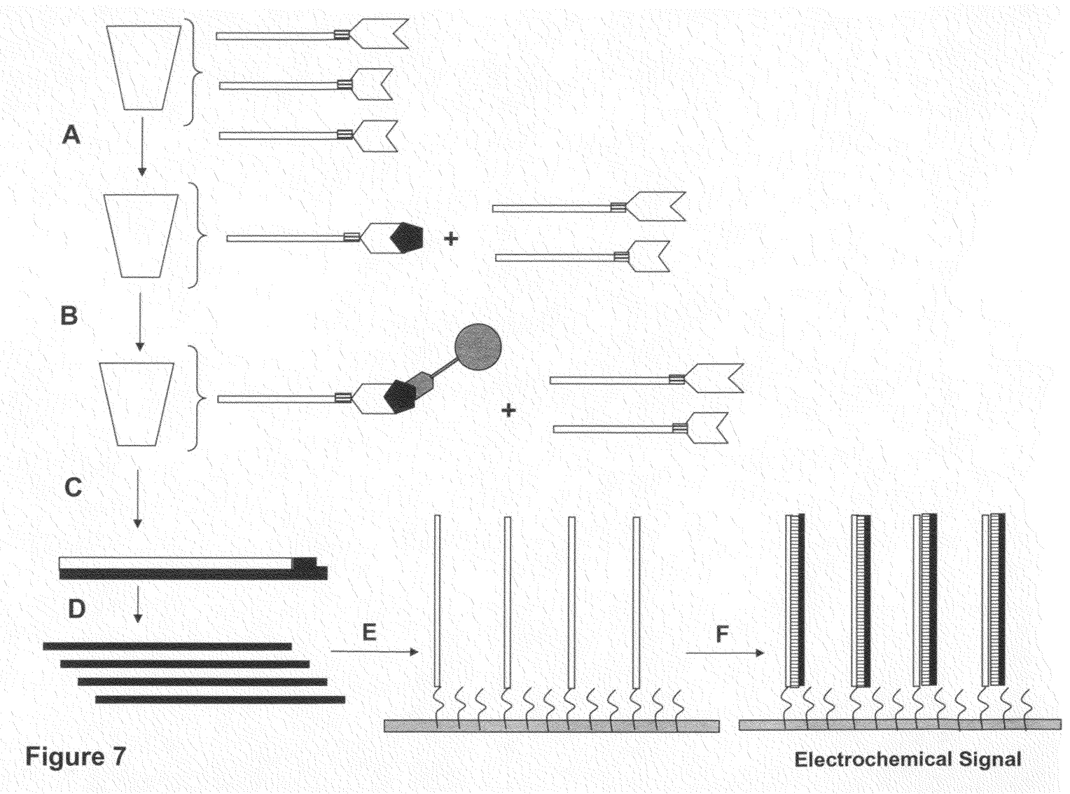

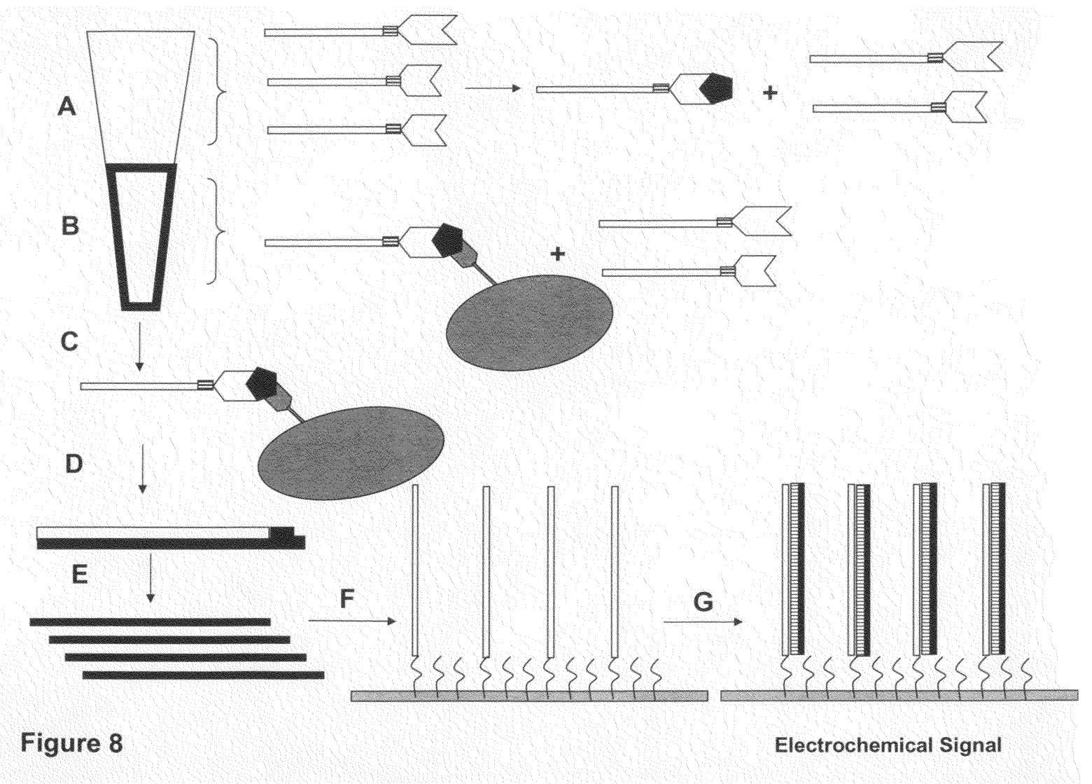

In a specific embodiment, the capture-associated oligo is used as a template for linear isothermal amplification, and the capture-associated oligo is therefore designed to encode the complementary sequence to a polymerase recognition sequence at its 3′ end following the region of complementarity to the biosensor-associated oligo. Following binding of the target agent to the capture-associated oligo complex and isolation from the sample, an oligonucleotide encoding the 5′ to 3′ polymerase recognition sequence is introduced to the reacted capture-associated oligo complex, and its binding to the complex creates a double-stranded polymerase recognition site. Following annealing of the oligonucleotide, an excess of single nucleotides and the appropriate polymerase are added to the solution containing the isolated reacted capture-associated oligo complex, and conditions are created to allow for polymerization and linear amplification. This reaction will continue as the polymerase displaces the newly synthesized oligo, resulting in multiple copies of the oligo, which is complementary to the capture-associated oligo. (See FIGS. 7 and 8.) In such an embodiment, the biosensor-associated oligo will have substantially the same sequence as the binding region of the capture-associated oligo, and both will be complementary to the linear amplification products.

In a preferred embodiment, the polymerase recognition site created by this double-stranded region is a phage-encoded RNA polymerase recognition sequence. Exemplary polymerases useful in such isothermal amplification reactions include RNA phage polymerases, including but not limited to T3 polymerase, SP6 polymerase, and T7 polymerase. In a more preferred embodiment, a mutant phage-encoded polymerase (e.g., the T7 RNA polymerase mutant Y639F or S641A) is used to allow creation of DNA rather than RNA. This will increase the stability of the synthesized oligos for binding to the biosensor-associated oligos, and obviate the problem of RNAse activity. Such mutant polymerases include T7 DNA polymerase, as disclosed in U.S. Pat. No. 6,531,300, U.S. Pat. No. 6,107,037, U.S. Pat. No. 5,849,546, and Padilla and Sousa, Nucleic Acids Res 1999 27(6):1561-1563, which are incorporated by reference herein.

A number of different nucleotides can be used in the isothermal linear amplification reaction. When using dNTPs and a traditional RNA polymerase, dUTP is substituted for dTTP. For those skilled in the art, it will be clear upon reading the present disclosure that modified nucleotides and nucleotide analogs that utilize a variety of combinations of functionality and attachment positions can be used in the present invention.

Asymmetric amplification using a heat stable polymerase such as Thermus aquaticus polymerase can also be used to create multiple copies of an oligo complementary to the biosensor-associated oligo. Suitable methods of asymmetric amplification are described in U.S. Pat. No. 5,066,584, which is incorporated by reference in its entirety. When this technique is used, an oligonucleotide complementary to the 3′ end of the capture-associated oligo is used under conditions to create a series of single-stranded molecules complementary to the capture-associated oligo. In such an embodiment, the biosensor-associated oligo will have will have substantially the same sequence as the binding region of the capture-associated oligo, and both will be complementary to the asymmetric amplification products.

Amplification using the Phi29 polymerase may also be used to create multiple copies of an oligo complementary to the biosensor-associated oligo. Such methods are described in U.S. Pat. No. 5,712,124 and U.S. Pat. No. 5,455,166, both of which are incorporated by reference in their entirety. In brief, the Phi29 polymerase method will allow amplification of the complementary oligo at a single temperature by utilizing the Phi29 polymerase in conjunction with an endonuclease that will nick the polymerized strand, allowing the polymerase to displace the strand without digestion while generating a newly polymerized strand. As with asymmetric amplification, an oligonucleotide complementary to the 3′ end of the capture-associated oligo is used under conditions to create a series of single-stranded molecules complementary to the capture-associated oligo. In such an embodiment, the biosensor-associated oligo will have will have substantially the same sequence as the binding region of the capture-associated oligo, and both will be complementary to the asymmetric amplification products.

In a particular embodiment of the invention, the capture-associated oligo is released from at least a portion of the reacted capture-associated oligo complex prior to linear or asymmetric amplification. This is illustrated in FIG. 8. Following binding of the target agent to the capture moiety and isolation from the sample, an oligonucleotide encoding the 5′ to 3′ polymerase recognition sequence and a restriction endonuclease sequence is introduced to the reacted capture-associated oligo complex, and its binding to the reacted capture-associated oligo complex creates both a double-stranded polymerase recognition site and a restriction endonuclease cleavage site. Following annealing of the oligonucleotide, the complex is exposed to the appropriate restriction endonuclease under conditions to allow the cleavage of the capture-associated oligo from at least a portion the reacted capture-associated oligo complex. The restriction endonuclease is then optionally inactivated (e.g., through heat inactivation by exposing the solution to a temperature of 65° C. for 10 minutes), and the capture-associated oligo is optionally isolated from the remainder of the reacted capture-associated oligo complex (e.g., the capture moiety bound to the target agent).

Following cleavage and optional inactivation or isolation, the capture-associated oligo with the bound oligonucleotide is exposed to an aqueous solution comprising an excess of single nucleotides and the appropriate polymerase, and conditions are created to allow for polymerization and linear amplification. This reaction continues as the polymerase displaces the newly synthesized oligo, resulting in multiple copies of the oligo, which is complementary to the capture-associated oligo. In such an embodiment, the biosensor-associated oligo will have will have substantially the same sequence as the binding region of the capture-associated oligo, and both will be complementary to the linear amplification products.

### Other Kit Components

The present invention as described is specifically directed to kits for use in performing the methods of the invention. Such kits can be used for detecting a variety of agents in samples, including proteins, carbohydrates, and any other agent with a specific binding epitope that is recognizable by the capture moieties used in the invention. The kits of the invention comprise a carrier, such as a box or carton, having in close confinement therein one or more vessels, such as vials, tubes, bottles and the like. In the kits of the invention, a first container contains one or more of the capture-associated oligo-capture moiety complexes. The kits of the invention may also comprise, in the same or different containers, at least one component selected from one or more RNA or DNA polymerases (preferably thermostable DNA polymerases), a suitable buffer for nucleic acid synthesis and one or more nucleotides. Alternatively, the components of the kit may be divided into separate vessels. In one aspect, the kits of the invention comprise a container containing an RNA polymerase in an appropriate buffered solution. In another aspect, the kits of the invention comprise a vessel containing a heat stable polymerase, e.g., Taq polymerase in an appropriate buffered solution. In additional preferred kits of the invention, the enzymes (RNA or DNA polymerases) in the containers are present at optimum working concentrations for the desired amplification reactions.

The binding of nucleic acids is carried out by means of simple lowering of the pH to below pH 6. For this, a binding buffer is used which can maintain a pH range from 1 to 6, preferably from 3 to 5. As is known, the purine bases of the nucleic acids have improved stability in the preferred pH range. Suitable buffers are, for example, formate, acetate, citrate buffers or other buffer systems which have adequate buffer capacity in the pH range mentioned.

The buffer concentration should be used in the range from 10 to 200 mM, depending on the buffer capacity of the sample liquid to be investigated. Preferably, a binding buffer concentration of 50 mM is used which has a pH of about 4.5, e.g., an acidic buffer which has been adjusted to a pH of between 4 and 5 using sodium hydroxide solution, potassium hydroxide solution or using tris base. Nuclease inhibitors can be added to the binding buffer; suitable nuclease inhibitors are known to the person skilled in the art.

### Methods Using the Devices and Kits of the Invention

The capture reaction (e.g., an antibody binding reaction) is performed in solution, typically in a physiological buffer such as phosphate buffered saline (PBS) supplemented with a non-specific blocking agent, such as new-born calf serum, and may be used when the target agent to be detected is normally found under physiological conditions. However, the methods of the present invention are not limited to detecting target agents only found in physiological conditions. Those of skill in the art would appreciate and understand that different capture moieties may be used in different conditions without affecting the ability to bind the particular target agent to be detected. The capture reaction can be performed at a temperature within the range of 0° C. to 100° C., preferably at a temperature between 2° C. and 40° C., and more preferably within the range of about 4° C. to about 37° C., and most preferably within the range of about 18° C. to about 25° C. The capture reaction is typically conducted from about 5 minutes to 12 hours, preferably from about 10 minutes to 6 hours, and more preferably from about 15 minutes to 1 hour. The duration of the capture reaction depends on several factors, including the temperature, suspected concentration of the target agent, ionic strength of the sample, and the like. For example, a capture reaction may require 15 minutes in length at a temperature of 18° C., or 30 minutes in length at a temperature of 4° C. Those of skill in the art would appreciate and understand the particular the specific time required for the reaction to be performed.

In some embodiments of the invention, cleavage of the capture-associated oligo from the reacted capture-associated oligo complex following separation of reacted and unreacted capture-associated oligo complexes, but prior to hybridization, is preferable. This situation may arise when the capture-associated oligos are conjugated to capture moieties that may interfere with hybridization, or electrochemical detection, because of the physical size or the presence of local areas of electron density on the surface of the capture moiety. Cleavage can be achieved by, for example, a digestive enzyme, i.e., an enzyme that causes hydrolysis of a bond in a molecule, (e.g., proteolytic enzymes, lipases, phosphatases, phosphodiesterases, esterases, etc.), endonucleases, exonucleases, a restriction endonuclease (e.g., EcoRI), or a flap endonuclease (e.g., FEN-1, RAD2, XPG, etc.). The choice of cleavage method will depend on the nature of the conjugation of the capture moiety to the capture-associated oligo, and the capture moiety to be removed via the cleavage reaction. For example, photocleavage may be employed where a photocleavable phosphoramidite is used in lieu of a restriction site. Those of skill in the art will readily appreciate and understand the circumstances under which one particular method of cleavage would be preferred over another method of cleavage.

For example, a digestive enzyme, such as trypsin, can be used when an antibody serving as the capture moiety is conjugated to a capture-associated oligo through an appropriate peptide linkage; a restriction endonuclease can be used when there is a specific sequence present in the capture-associated oligo encoding a restriction site for a particular restriction endonuclease, between the binding region of the capture-associated oligo and the region that is conjugated to the capture moiety. In specific embodiments, restriction sites and restriction endonucleases are chosen that allow cleavage of single-stranded nucleic acids. Likewise, a flap endonuclease, such as RAD2, or XPG, could be used when there is a specific structure present in the capture-associated oligo susceptible to the particular flap endonuclease, between the binding region of the capture-associated oligo and the region that is conjugated to the capture moiety. Those of skill in the art would appreciate and understand the particular types of structure susceptible to flap endonuclease cleavage.

Where it is intended that a restriction endonuclease will be used to separate the capture-associated oligo from the capture-associated oligo complex, the capture-associated oligo will be engineered to contain a specific restriction site between the binding region of the capture-associated oligo and the portion of capture-associated oligo that is conjugated to the capture moiety. This restriction site will be designed, and the appropriate restriction endonuclease selected, to cleave only in the portion of the capture-associated oligo that is conjugated to the capture moiety and not in the binding region of the capture-associated oligo.

In those embodiments where such cleavage is performed, the cleavage reaction is performed after the capture reaction has been completed and after a selective purification reaction is employed in order to segregate the desired reaction product (i.e., the composition comprising the reacted capture-associated oligo complex); for example, the reaction product can be subjected to a secondary capture (e.g., using a secondary immobilized antibody as a binding partner) followed by separation and wash procedures. The immobilized reacted capture-associated oligo complex may then be eluted or otherwise separated from the substrate upon which the binding partner is bound, and the resulting solution containing the reacted capture-associated oligo complex transferred to the biosensor for hybridization and electrochemical detection device for signal detection.

The hybridization reaction between the biosensor-associated oligos and the capture-associated oligos is typically performed in solution where the metal ion concentration of the buffer is between 0.01 mM to 5 M and a pH range of pH 5 to pH 10. Other components can be added to the buffer to promote hybridization such as dextran sulfate, EDTA, surfactants, etc. The hybridization reaction can be performed at a temperature within the range of 10° C. to 90° C., preferably at a temperature within the range of 25° C. to 60° C., and most preferably at a temperature within the range of 30° C. to 50° C. Alternatively, the temperature is chosen relative to the Tₘ's of the nucleic acid molecules employed. The reaction is typically performed at an incubation time from 10 seconds to about 12 hours, and preferably an incubation time from 30 seconds to 5 minutes. A variety of hybridization conditions may be used in the present invention, including high, moderate and low stringency conditions; see for example Maniatis et al., Molecular Cloning: A Laboratory Manual, 3rd Edition (2001), hereby incorporated by reference. Persons of ordinary skill in the art will recognize that stringent conditions are sequence-dependent and are dependent upon the totality of the conditions employed. Longer sequences typically hybridize specifically at higher temperatures. Generally, stringent conditions are selected to be about 5-10° C. lower than the thermal melting point (Tm) for the specific sequence at a defined ionic strength pH. Stringent conditions will be those in which the salt concentration is less than about 1.0 M sodium ion, typically about 0.01 to 1.0 M sodium ion concentration (or other salts) at pH 7.0 to 8.3 and the temperature is at least about 30° C. for short probes (e.g. 10 to 50 nucleotides) and at least about 60° C. for long probes (e.g. greater than 50 nucleotides). Stringent conditions may also be achieved with the addition of destabilizing agents such as formamide. The hybridization conditions may also vary when a non-ionic backbone, i.e., PNA is used. The hybridization reaction can also be controlled electrochemically by applying a potential to the electrodes to speed up the hybridization. Alternatively, the potential can be adjusted to ensure specific hybridization by increasing the stringency of the conditions.

Conjugation of oligos to the capture moieties may be performed in numerous ways, providing it results in a capture moiety possessing both epitope-specific binding to capture the target agent as well as providing it does not restrict nucleic acid hybridization functionalities in embodiments where a cleavage is not performed, to allow detection of the bound target agent. For example, oligo-antibody conjugates (e.g., where an antibody is the capture moiety) can be synthesized by using heterobifunctional cross-linker chemistries to covalently attach single-stranded DNA labels through amine or sulfhydryl groups on an antibody to create a capture agent of the invention. Hendricksen E R, Nucleic Acids Res. (1995) February 11; 23(3):522-9. In another example, covalent single-stranded DNA-streptavidin conjugates, capable of hybridizing to complementary surface-bound oligonucleotides, are utilized for the effective immobilization of biotinylated capture moieties. Niemeyer C M, et al., Nucleic Acids Res. 2003 Aug. 15; 31(16):90. Many other nucleic acid molecular conjugates are described in Heidel J et al., Adv Biochem Eng Biotechnol. (2005); 99:7-39. Additional methods of creating oligo-capture moiety conjugates, both those existing and under development, will be apparent to one skilled in the art upon reading the present disclosure, and such methods are intended to be captured within the methods of the invention.

### Detection on the Biosensor

Electrochemical detection of a hybridization event can be enhanced by the use of an electrochemical hybridization detector. In certain preferred embodiments, an electrochemical hybridization detector is an agent that binds to double-stranded nucleic acid, but does not bind to single-stranded nucleic acid. In such embodiments, the electrochemical hybridization detector would only bind to the electrode-associated oligo if it has hybridized with a complementary oligo (e.g., a capture-associated oligo) to create a double-stranded nucleic acid. An electrochemical hybridization detector can be, for example, an intercalating agent characterized by a tendency to intercalate specifically into double-stranded nucleic acids such as double-stranded DNA. Intercalating agents have in their molecules a flat (planar) intercalating group such as a phenyl group, which preferentially intercalates between the base pairs of the double-stranded nucleic acid. Most intercalating agents comprise conjugated electron structures and are therefore optically active; some are commonly used in the quantification or visualization of nucleic acids. Certain intercalating agents exhibit an electrode response, thereby generating or enhancing an electrochemical response. As such, determination of physical change, especially electrochemical change, may serve to detect the intercalating agents bound to a double-stranded nucleic acid and so enhance the detection of a hybridization reaction. In other embodiments, an electrochemical hybridization detector is an agent that binds differently to double-stranded nucleic acid than it does to single-stranded nucleic acid in such a way that the electrochemical signal produced from a double-stranded nucleic acid bound to the agent is stronger or otherwise enhanced relative to a single-stranded nucleic acid bound to the agent.

Electrochemically active intercalating agents useful in the present invention are, but are not limited to, ethidium, ethidium bromide, acridine, aminoacridine, acridine orange, proflavin, ellipticine, actinomycin D, daunomycin, mitomycin C, Hoechst 33342, Hoechst 33258, aclarubicin, DAPI, Adriamycin, pirarubicin, actinomycin, tris(phenanthroline)zinc salt, tris(phenanthroline)ruthenium salt, tris(phenantroline)cobalt salt, di(phenanthroline)zinc salt, di(phenanthroline)ruthenium salt, di(phenanthroline)cobalt salt, bipyridine platinum salt, terpyridine platinum salt, phenanthroline platinum salt, tris(bipyridyl)zinc salt, tris(bipyridyl)ruthenium salt, tris(bipyridyl)cobalt salt, di (bipyridyl)zinc salt, di(bipyridyl)ruthenium salt, di(bipyridyl)cobalt salt, and the like. Other useful intercalating agents are those listed in Published Japanese Patent Application No. 62-282599. Some of these intercalators contain metal ions and can be considered transition metal complexes. Although the transition metal complexes are not limited to those listed above, complexes which comprise transition metals having oxidation-reduction potentials not lower than or covered by that of nucleic acids are less preferable. The concentration of the intercalator depends on the type of intercalator to be used, but it is typically within the range of 1 ng/mL to 1 mg/mL. Some of these intercalators, specifically Hoechst 33258, have been shown to be minor-groove binders and specifically bind to double-stranded DNA. The use of such electrochemically active minor groove binders is useful for detection of hybridization in electrochemical detection methods. Thus, in accordance with the present invention, the term “intercalator” is not intended to be limited to those compounds that “intercalate” into the rungs of the DNA ladder structure, but is also intended to include any moiety capable of binding to or with nucleic acids including major and minor groove-binding moieties.

Additionally, intercalators may be used for electrochemical detection where the intercalator molecule itself may or may not be able to enhance electrochemical detection, but where the intercalator is conjugated to molecules that enhance electrochemical detection (electrochemical enhancing conjugates) in a formula such as I—(X)ₘ—(Y)ₙ, where I is an intercalator, X is a linking moiety, and Y is an electrochemical enhancing entity (such as an electron acceptor). For example, the minor groove binder Hoechst 33258, itself an electrochemical detection enhancer, may be conjugated to additional molecules of Hoechst 33258, another intercalator, an organometallic electrochemical detection enhancer, metallocene, or any other electrochemical enhancing entity. The electrochemical enhancing entities can be attached to the intercalator by covalent or non-covalent linkages. If the electrochemical enhancing entities are attached covalently, the functional groups include haloformyl, hydroxy, oxo, alkyl, alkenyl, alkynyl, amide, amino, ammonio, azo, benzyl, carboxy, cyanato, thiocyanato, alkoxy, halo, imino, isocyano, isothiocyano, keto, cyano, nitro, nitroso, peroxy, phenyl, phosphino, phosphono, phospho, pyridyl, sulfonyl, sulto, sulfinyl, or mercaptosylfanyl, with preferred functional groups being amino, carboxy, oxo, and thiol groups, and with amino groups being particularly preferred. In addition, homo- or hetero-bifunctional linkers may be used and are well known in the art. As will be appreciated by those in the art, a wide variety of intercalators, electrochemical enhancing entities and functional groups may be used.

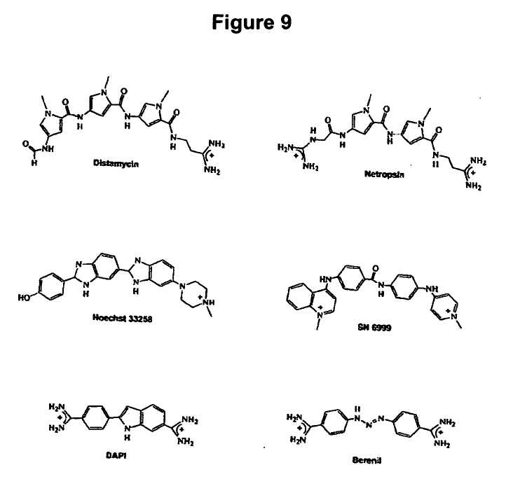

In one specific embodiment of the invention, the nucleic acid duplex detection is an electrochemical detection binders of the netropsin family, which includes netropsin, distamycin, DAPI, SN 6999, Berenil, and Hoechst 33258. Each of these molecules has a curved, planar aromatic core, and positively charged groups and hydrogen-bond donors on the convex edge (See FIG. 9). Both the shape and the functional group complementarity with the nucleic acid sequence are critical features for the binding of these ligands to the nucleic acid duplex.

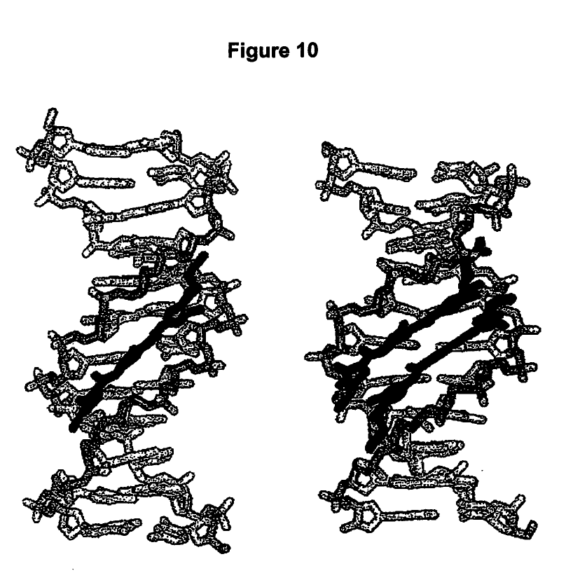

The binding ratio of the minor groove ligands may be either in a 1:1 ratio in the minor groove (FIG. 10A) or in a 2:1 ratio (FIG. 10B). In the latter case, the ligands will be bound side by side in the minor groove, running antiparallel. See e.g., The preference for 1:1 versus 2:1 binding will be largely be a function of the groove shape of the nucleic acid duplex, as the 2:1 binding of the ligand results in a minor groove that is widened by approximately 3.5 to 4 Å relative to the 1:1 complexes.

Transition metals are those whose atoms have a partial or complete d orbital shell of electrons. Suitable transition metals for use in conjunction with the present invention include, but are not limited to, cadmium (Cd), copper (Cu), cobalt (Co), palladium (Pd), zinc (Zn), iron (Fe), ruthenium (Ru), rhodium (Rh), osmium (Os), rhenium (Re), platinum (Pt), scandium (Sc), titanium (Ti), vanadium (V), chromium (Cr), manganese (Mn), nickel (Ni), molybdenum (Mo), technetium (Tc), tungsten (W), and iridium (Ir). That is, the first series of transition metals, the platinum metals (Ru, Rh, Pd, Os, Ir and Pt), along with Fe, Re, W, Mo and Tc, are preferred. Particularly preferred are ruthenium, rhenium, osmium, platinum, cobalt and iron.

The transition metals are commonly complexed with a variety of ligands, to form suitable transition metal complexes. As will be appreciated by those in the art, the number and nature of the co-ligands will depend on the coordination number of the metal ion. Mono-, di- or polydentate co-ligands may be used at any position. Suitable ligands fall into two categories: ligands, which use nitrogen, oxygen, sulfur, carbon or phosphorus atoms (depending on the metal ion) as the coordination atoms (generally referred to in the literature as sigma (Σ) donors) and organometallic ligands such as metallocene ligands (generally referred to in the literature as pi (π) donors). Suitable nitrogen donating ligands are well known in the art and include, but are not limited to, NH₂; NHR; NRR′; pyridine; pyrazine; isonicotinamide; imidazole; bipyridine and substituted derivatives of bipyridine; terpyridine and substituted derivatives; phenanthrolines, particularly 1,10-phenanthroline (abbreviated phen) and substituted derivatives of phenanthrolines such as 4,7-dimethylphenanthroline and dipyridol[3,2-a:2′,3′-c]phenazine (abbreviated dppz); dipyridophenazine; 1,4,5,8,9,12-hexaazatriphenylene (abbreviated hat); 9,10-phenanthrenequinone diimine (abbreviated phi); 1,4,5,8-tetraazaphenanthrene (abbreviated tap); 1,4,8,11-tetra-azacyclotetradecane (abbreviated cyclam), EDTA, EGTA and isocyanide. Substituted derivatives, including fused derivatives, may also be used. In some embodiments, porphyrins and substituted derivatives of the porphyrin family may be used. See for example, Comprehensive Coordination Chemistry, Ed. Wilkinson et al., Pergammon Press, 1987, Chapters 13.2 (pp. 73-98), 21.1 (pp. 813-898) and 21.3 (pp. 915-957), all of which are hereby expressly incorporated by reference.

Suitable sigma donating ligands using carbon, oxygen, sulfur and phosphorus are known in the art. For example, suitable sigma carbon donors are found in Cotton and Wilkinson, Advanced Organic Chemistry, 5th Edition, John Wiley & Sons (1988), hereby incorporated by reference; see, e.g., page 38. Similarly, suitable oxygen ligands include crown ethers, water and others known in the art. Phosphines and substituted phosphines are also suitable; see, e.g., page 38 of Cotton and Wilkinson. The oxygen, sulfur, phosphorus and nitrogen-donating ligands are attached in such a manner as to allow the heteroatoms to serve as coordination atoms.

Such organometallic ligands include cyclic aromatic compounds such as the cyclopentadienide ion [C₅H₅ (−1)] and various ring substituted and ring fused derivatives, such as the indenylide (−1) ion, that yield a class of bis(cyclopentadieyl)metal compounds, (e.g. the metallocenes); see, e.g., Robins et al., J. Am. Chem. Soc. 104:1882-1893 (1982); and Gassman et al., J. Am. Chem. Soc. 108:4228-4229 (1986), incorporated by reference. Of these, ferrocene [(C₅H₅)₂ Fe] and its derivatives are prototypical examples, which have been used in a wide variety of chemical (Connelly et al., Chem. Rev. 96:877-910 (1996), incorporated by reference) and electrochemical (Geiger et al., Advances in Organometallic Chemistry 23:1-93; and Geiger et al., Advances in Organometallic Chemistry 24:87, incorporated by reference) electron transfer or “redox” reactions. Metallocene derivatives of a variety of the first, second and third row transition metals are potential candidates as redox moieties that are covalently attached to the nucleic acid. Other potentially suitable organometallic ligands include cyclic arenes such as benzene, to yield bis(arene)metal compounds and their ring substituted and ring fused derivatives, of which bis(benzene)chromium is a prototypical example. Other acyclic pi-bonded ligands such as the allyl(−1) ion, or butadiene yield potentially suitable organometallic compounds, and all such ligands, in conjunction with other pi-bonded and delta-bonded ligands constitute the general class of organometallic compounds in which there is a metal to carbon bond. Electrochemical studies of various dimers and oligomers of such compounds with bridging organic ligands, and additional non-bridging ligands, as well as with and without metal-metal bonds are potential candidate redox moieties in nucleic acid analysis.

When one or more of the co-ligands is an organometallic ligand, the ligand is generally attached via one of the carbon atoms of the organometallic ligand, although attachment may be via other atoms for heterocyclic ligands. Preferred organometallic ligands include metallocene ligands, including substituted derivatives and the metalloceneophanes (see page 1174 of Cotton and Wilkenson, supra). For example, derivatives of metallocene ligands such as methylcyclopentadienyl, with multiple methyl groups being preferred, such as pentamethylcyclopentadienyl, can be used to increase the stability of the metallocene. In a preferred embodiment, only one of the two metallocene ligands of a metallocene is derivatized.

Alternatively, in some embodiments, a capture-associated oligo may be labeled with an electroactive marker. These markers may serve to enhance or otherwise facilitate detection of hybridization between an electrode-associated oligo and an capture-associated oligo. For example, these markers may enhance an electrochemical signal generated when hybridization has occurred on an electrode. Such electroactive markers can include, but are not limited to, ferrocene derivatives, anthraquinone, silver and silver derivatives, gold and gold derivatives, osmium and osmium derivatives, ruthinium and ruthinium derivatives, cobalt and cobalt derivatives, and the like. In some embodiments, one or more electroactive markers may be used in combination with one or more electrochemical hybridization detectors to enhance detection of a hybridization event between a capture-associated oligo and a biosensor-associated oligo. For example, an intercalator may be used in combination with an electroactive marker in a formula (I—(X)ₘ—(Y)ₙ, where I is the intercalator, X is a linking moiety, and Y is the electroactive marker.

Electrochemical detection of a hybridization event can be enhanced by the use of an agent to reduce background signal from, for example, nonspecific binding of a electrochemical hybridization detector to single-stranded electrode-associated oligos. Such binding may result in an increase of signal at an electrode comprising electrode-associated oligos that are not hybridized to any capture-associated, thereby increasing background signal and potentially obscuring signal produced from actual hybridization events, which can hinder quantification of target agent in the sample. An agent to reduce background signal may be, for example, a single-stranded nuclease such as mung bean nuclease, nuclease PI, exonuclease I, exonuclease VII, or S1 nuclease, all of which are specific for digestion of single-stranded DNA (see, e.g., Desai, N. A. et al. (2003) FEMS Microbiol Review 26(5):457-91; and Sambrook, J. et al. (1989) Molecular Cloning: A Laboratory Manual (2^{nd} ed.), New York: Cold Spring Harbor Laboratory Press) The use of a single-strand-specific exonuclease would serve to remove oligos that did not hybridize with complementary oligos from the array prior to detection of signal. In some embodiments, exonuclease treatment precedes addition of an electrochemical hybridization detector. In other embodiments, a single-strand-specific binding protein may be used to block binding of an electrochemical hybridization detector to single-stranded DNA. For example, E. coli single-stranded DNA binding protein (SSB) may be used, preferably prior to addition of an electrochemical hybridization detector (see e.g., Krauss, G. et al. (1981) Biochemistry 20:5346-5352 and Weiner, J. H. et al. (1975) J. Biol. Chem. 250:1972-1980).

One advantage of a simultaneous accurate detection method includes an increased speed at which multiple suspected target agents can be eliminated. For example, a patient can provide a sample that can quickly be tested for the presence of multiple suspected target agents (e.g., toxins, strains of bacteria and/or viruses, etc.). Such a rapid and accurate test can aid in the treatment of the condition, e.g., where no bacterial infection is found there is no need to treat with antibiotics. Similarly, improper use of antibiotics can be reduced or eliminated by ensuring that the proper antibiotic, specific for the detected infectious agent, is administered. Likewise, the cause of potential food-poisoning outbreaks, or terrorist attacks can be ascertained in a short space of time, and the relevant treatment regimen implemented, e.g., antibiotics for bacterial causes, antivirals for viral causes, and chemical antidotes for toxin causes. Additionally, the construction of complete test panels that can be specific for the particular type of sample, or for the particular suspected underlying diseases or agents is another advantage of this particular method. For example, one could construct a test panel for sexually transmitted diseases, another panel for common blood borne diseases, yet another for airborne pathogens, yet another for terrorist agents (biological and/or chemical), yet another for common childhood disease. These are only representative examples of possible uses and are not intended to limit the scope of the invention in any way. Those of skill in the art would appreciate and understand the particular agents and combinations that could be used in a particular test panel.

In another embodiment, the panel is selected so as to provide an indication of the particular strain of one or more pathogenic agents and, in particular, to provide an accurate indication of the proper treatment is to be administered. For example, a specific subset of agents (e.g., HCV proteins) can be used to indicate the particular viral strain infecting a patient, which has important implications for treatment options and can help determine which patients will be better responders to medications such as interferons. Thus, by employing the present invention, a rapid and accurate screen can be performed whereby specific infectious strains are identified and the proper treatment regime determined.

### EXAMPLE I

### Preparation of Monoclonal Antibodies

A peptide corresponding to amino acid residues in a desired antigen is synthesized with a peptide synthesizer (Applied Biosystems) according to methods known in the art. The peptide emulsified with Freund's complete adjuvant is used as an immunogen and administered to mice by footpad injection for primary immunization (day 0). The booster immunization is performed four times or more in total. The final immunization is carried out by the same procedure two days before the collection of lymph node cells. The lymph node cells collected from each immunized mouse and mouse myeloma cells are mixed at a ratio of 5:1. Hybridomas are prepared by cell fusion using polyethylene glycol 4000 or polyethylene glycol 1500 (GIBCO) as a fusing agent. The lymph node cells of the mouse are fused with mouse myeloma PAI cells (JCR No. B0113; Res. Disclosure Vol. 217, p. 155, 1982), and the resulting hybridomas are selected by culturing the fused cells in an ASF104 medium (Ajinomoto Co. Inc.) containing HAT supplemented with 10% fetal calf serum (FCS) and aminopterin. The reactivity of the culture supernatant of each hybridoma clone is measured by ELISA.

Screening by ELISA is performed by adding the immunogen into each well of a 96-well ELISA microplate (Corning Costar Co.). The plate is incubated at room temperature for 2 hours for the adsorption of the immunogen onto the microplate. The supernatants are discarded and then the blocking reagent (200 μl; phosphate buffer containing 3% BSA) is added into each well. The plate is incubated at room temperature for 2 hours to block free sites on the microplate. Each well is washed three times with 200 μl of phosphate buffer containing 0.1% Tween 20. Supernatant (100 μl) from each hybridoma culture is added into each well of the plate, and the reaction is allowed to proceed for 40 minutes. Each well is then washed three times with 200 μl of phosphate buffer containing 0.1% Tween 20. In the next step, biotin-labeled sheep anti-mouse immunoglobulin antibody (50 μl; Amersham) is added to the wells and the plates are incubated at room temperature for 1 hour.

The microplate is washed with phosphate buffer containing 0.1% Tween 20. A solution of streptavidin-β-galactosidase (50 μl; Gibco-BRL), diluted 1000 times with a solution (pH 7.0) containing 20 mM HEPES, 0.5 M NaCl and bovine serum albumin (BSA, 1 mg/mL), is added into each well. The plate is then incubated at room temperature for 30 minutes. The microplate is then washed with phosphate buffer containing 0.1% Tween 20. A solution of 1% 4-Methyl-umbelliferyl-β-D-galactoside (50 μl; Sigma) in a phosphate buffer (pH 7.0) containing 100 mM NaCl, 1 mM MgCl₂ and 1 mg/mL BSA, is added into each well. The plate is incubated at room temperature for 10 minutes. 1 M Na₂CO₃ (100 μl) is added into each well to stop the reaction. Fluorescence intensity is measured in a Fluoroscan II Microplate Fluorometer (Flow Laboratories Inc.) at a wavelength of 460 nm (excitation wavelength: 355 nm).

### EXAMPLE II

### Preparation of DNA-Antibody Conjugates

Oligonucleotide #109745 (5′ amino-modified, 88 nucleotides in length) was synthesized using standard phosphoramidite chemistry (Biosearch Technologies, Inc., Novato, Calif.) having the following nucleotide sequence: 5′-ATCTGCAGGGAGTCAACCTTGTCCGTCCATTCTAAACCGTTGTGCGTCC GTCCCGATTAGACCAACCCCCCTATAGTGAGTCGTATTA-3′. The oligonucleotide was purified using a NAP-5 column (0.1 M/0.15 M buffer of NaHCO₃/NaCl, pH 8.3).

0.2 mL of a 100 μM aqueous solution of oligonucleotide #109745 was loaded onto a column. After 0.3 mL buffer was added, 0.8 mL of eluant was collected and quantified. Based on A₂₆₀ reading, more than 90% of recovery was observed.

The purified oligonucleotide was chemically modified using Succinimidyl 4-formylbenzoate (C6-SFB). 790 μL of purified oligonucleotide and 36 μL of C6-SFB (20 mM in DMF (dimethylformamide)) were mixed (1:40 ratio) and incubated at room temperature for 2 hours. The reaction product was cleaned up using a 5 mL HiTrap desalting column (GE Heathcare) and 1.5 mL eluant was collected. Based on A₂₆₀ reading, more than 80% of oligonucleotide-C6-SFB was recovered.

A Rabbit-anti-Klebsiella antibody (Biodesign, B65891R) was purified using a NAP-5 column (1×PBS buffer, pH 7.2) per manufacturer's instructions. Specifically, 0.25 mL of Rabbit-anti-Klebsiella antibody (4-5 mg/mL) was loaded onto the column, and based on A₂₈₀ reading, 1.27 mg/mL (8.4 μM) antibody was recovered.

Purified Rabbit-anti-Klebsiella antibody was chemically modified using Succinimidyl 4-hydrazinonicotionate acetone hydrazone (C6-SANH). 950 μL of 8.4 μM of Rabbit-anti-Klebsiella antibody and 10.4 μL of C6-SANH (10 mM in DMF) were mixed (1:20 ratio) and incubated at room temperature for 30 minutes. The reaction product was cleaned up using a 5 mL HiTrap desalting column (GE Healthcare) and 1.25 mL eluant was collected. A BCA (“bicinchoninic acid”; Pierce, cat #23225 or #23227) or Bradford (Pierce, cat #23225 or #23236) assay was used to determine the concentration of recovered Rabbit-anti-Klebsiella antibody-C6-SANH (typically ˜1 mg/mL, yield more than 95%). (BSA (bovine serum albumin) was used as the standard for the BCA assay.)

The conjugation of Rabbit-anti-Klebsiella antibody and oligonucleotide was typically achieved by mixing the 1010 μL of Rabbit-anti-Klebsiella antibody-C6-SANH and 750 μL of oligonucleotide-C6-SFB in a molar ratio 1:2 and incubated overnight at room temperature. The resulting conjugates were analyzed on a TBE/UREA gel system, and purified using MiniQ FPLC (fast protein liquid chromatography).

The standard gradient approach was utilized using MiniQ 4.6/50 PE column (GE Healthcare, cat #17-5177-01; 0.25 mL/min flow rate; detection at 280 nm; Buffer A: 20 mM Tris/HCl, pH 8.1; and Buffer B: 20 mM Tris/HCl, 1 M NaCl, pH 8.1). A BCA or Bradford assay was used to determine the concentration of recovered Rabbit-anti-Klebsiella antibody-oligonucleotide conjugate (˜3 mL of eluant, 0.11 mg/mL).

### EXAMPLE III

### Immobilization of an Electrode-associated Oligo to a Gold Electrode Surface

The gold electrodes on the chip (Nanostructures, Inc., Santa Clara, Calif.) were cleaned immediately prior to use in UV/ozone cleaner (UVOCS, model T16X16/OES) for 10 minutes. Cleaned chips were stored in container under inert gas (argon).

5′-thiolated oligonucleotides with a C₆ linker were synthesized using standard phosphoramidite chemistry (Biosearch Technologies, Inc. Novato, Calif.).

The spotting solution was prepared by mixing 5′-thiolated C₆ oligonucleotides with mercaptohexanol (MCH) and KHPO₄. Typically, the probe spotting solution consists of a 100 μM thiolated oligo, 1 mM MCH, and 400 mM KHPO₄ (pH 3.8) buffer in aqueous solution.

Chips were printed (30 nl/spot) using BioJet Plus™ series AD3200 non-contact spotter (BioDot, Irvine, Calif.). The relative humidity during the printing was 85%. After incubation of the slides in a humidity chamber for 4 hrs, they were rinsed with an excess of distilled water, dried with argon, and kept in dark under argon at room temperature until use.

### EXAMPLE IV

### Binding of Target Agent and Removal of Excess Capture-Associated Oligo Complexes

### Model System Study

An oligonucleotide AminoR-100003-T7 (5′ amino modified 88 nucleotides long) was synthesized using standard phosphoramidite chemistry (Biosearch Technologies, Inc. Novato, Calif.) and was purified as described in Example II, and had the following sequence:

5′-ATCTGCAGGCCAGGATGACACCTAGATCGTGGTGATCGGGAG
TGTGTCCACGTGACCAACCCCTATAGCCCTATAGTGAGTCGTATTA-3′

The oligonucleotide (AminoR-100003-T7) was conjugated to an anti-Mouse α-Human IL-8 Monoclonal Antibody (ELISA capture, BD Pharmingen, cat #554716) according to the procedure for conjugation described in Example II. Typically 0.1 mg/mL of the conjugate was obtained. The conjugate therefore contained the AminoR-100003-T7 oligonucleotide (capture-associated oligo) and the anti-Mouse α-Human IL-8 Monoclonal Antibody (capture moiety).

In parallel, NHS (N-hydroxylsuccinimidyl ester) activated agarose beads (GE Healthcare cat. #17090601, medium) were conjugated to an anti-Mouse α-Human IL-8 Monoclonal Antibody (for immunocytochemistry, BD Pharmingen, cat. #550419). First, Mouse α-Human IL-8 Monoclonal Antibody was purified using a NAP-5 column (0.1 M/0.15 M buffer of NaHCO₃/NaCl, pH 8.3), 0.5 mL was loaded, 0.1 mL buffer was added, and 0.7 mL eluate was collected.

0.5 mL of NHS-activated agarose beads (GE, cat #17-0906-01, medium) was sequentially washed with ice-cold 1 mM HCl and ice-cold water. Then, 0.7 mL of Mouse α-Human IL-8 Monoclonal Antibody was added and incubated for 3 hours at room temperature with gentle shaking.

0.5 mL of supernatant from the reaction mixture was passed through a NAP-5 column and a high molecular weight fraction at A₂₈₀ was collected. Subsequently, the agarose beads were blocked with 0.2 M ethanolamine in 0.1 M/0.15 M buffer of NaHCO₃/NaCl (pH 8.3) for 2 hours at room temperature with gentle shaking, and then washed 4 times with 5 mL of 50 mM Tris/HCl, 150 mM NaCl (pH 8.1). After final wash, 0.6 grams of gel was aliquoted, 0.6 mL of 50 mM Tris/HCl, NaCl 150 mM (pH 8.1), 0.1% azide was added, and the mixture was stored at 4° C. Typically, conjugation yields 0.3 mg of antibodies per 1 mL of settled agarose beads. The above-mentioned monoclonal antibodies represent a pair recognizing two different epitopes of recombinant Human IL-8. (The anti-Mouse α-Human IL-8 Monoclonal Antibody on the agarose beads served as an immobilized binding partner.)

To reconstitute a model system, 0.5 μg of target agent, recombinant Human IL-8 (BD Pharmingen, cat #554609, 0.1 mg/mL), was spiked into FBS (Fetal Bovine Serum) along with the AminoR-100003-T7/Mouse α-Human IL-8 Monoclonal AB conjugate (capture-associated oligo complex) (typically 20 μg was used).

15 μg (50 μl) of settled agarose bead-Mouse α-Human IL-8 Monoclonal Antibody conjugate (immobilized binding partner) (100 μL of 50% slurry) was blocked by mixing with Fetal Bovine Serum for 45 minutes at room temperature. The resulting reaction mixture was briefly centrifuged and supernatant was discarded. The above-mentioned reconstituted model system (Human IL-8 and oligo-antibody conjugate) was added to the remaining intact bead bed and the volume of reaction mixture was brought to 500 μL with PBS (phosphate-buffered saline). The reaction mixture, after adding BSA to a final concentration of 1 mg/mL, was incubated at room temperature with continuous mixing.

Unbound oligonucleotide-antibody conjugates (unreacted capture-associated oligo complexes) were removed by washing with PBS (7 times). After the last wash the supernatant was carefully removed and the volume of the bead bed was brought up to 100 μL with PBS. The target-bound conjugates (reacted capture-associated oligo complexes) remained on the agarose beads and were available for detection.

### EXAMPLE V

### Cleavage of a Capture Moiety from a Capture-Associated Oligo

Following the isolation of the target-bound conjugates (reacted capture-associated oligo complexes), it may be desirable in some instances to remove the capture moiety (e.g., antibody) and the target agent from the nucleic acid prior to hybridization. This is accomplished by performing a cleavage reaction to cleave the capture-associated oligo complex between the portion of the capture-associated oligo that will hybridize to the electrode-associated oligo and the capture moiety.

An oligonucleotide is synthesized as described in Example II with a “G-G-C-C” sequence between the capture moiety and the portion of the capture-associated oligo that will hybridize to the electrode-associated oligo. The restriction endonuclease, HaeIII (New England Biolabs), has been shown to cleave single-stranded DNA at this specific sequence (Horiuchi & Zinder, 1975). The cleavage reaction is performed by mixing the HaeIII enzyme with the capture-associated oligo complexes in a buffer containing 10 mM Tris-HCl, 50 mM NaCl, 10 mM MgCl₂, and 1 mM dithiothreitol, pH 7.9, and incubating at 37° C. for 30 minutes. The HaeIII enzyme is heat-inactivated at 80° C. for 20 minutes. The cleaved oligos are separated from the remainder of the capture-associated oligo complex by standard techniques such as ethanol precipitation. Briefly, add 2.5-3 volumes of 95% ethanol/0.12 M sodium acetate to the DNA sample contained in a 1.5 mL microcentrifuge tube, invert to mix, and incubate in an ice-water bath for 10 minutes. The resulting mixture is centrifuged at 12,000 r.p.m. in a microcentrifuge for 15 minutes at 4° C., the supernatant is decanted, and the pellet is drained by inversion on a paper towel. Ethanol (80%) (corresponding to about two volume of the original sample) is added and the reaction mixture is incubated at room temperature for 5-10 minutes followed by centrifugation for 5 minutes. The supernatant is then decanted. The sample is air-dried (or alternatively lyophilized) and the pellet of DNA resuspended in 10 mM Tris-HCl, pH 7.6-8.0, 0.1 mM EDTA. For hybridization reactions, the nucleic acid is resuspended in SSC solution.

In an alternative cleavage method, photocleavage is performed. In doing so, an oligonucleotide is synthesized as described in Example II with a photocleavable nucleotide inserted into the sequence. This can be accomplished by using a photocleavable phosphoramidite during the synthesis of the oligonucleotide (Glen Research). The cleavage reaction is essentially performed by exposing the capture-associated oligo complex to a source of ultraviolet (UV) light. The cleaved oligos are separated from the remainder of the capture-associated oligo complex by standard techniques such as ethanol precipitation, membrane filtration, or if the remainder of the capture-associated oligo complex is immobilized, centrifugation, etc.

### EXAMPLE VI

### Hybridization of Nucleic Acid Molecules to the Electrode-Associated Oligos

The hybridization and detection reaction was carried out as follows. The printed DNA chip containing the electrode-associated oligos was assembled into a PAR 2-chamber cartridge (Antara BioSciences Inc., custom design). 500 μL of target hybridization solution and 10 nM single-stranded nucleic acid (60 nucleotides long) in 6×SSPE buffer (0.9 M NaCl, 60 mM NaH₂PO₄, 6 mM EDTA) was injected into the cartridge. The hybridization reaction was carried out in the 55° C. oven for 60 minutes with gentle shaking. Then, the hybridization solution was pipetted off and the chips were rinsed twice with 500 μL of pre-warmed (55° C.) 0.2×SSC (30 mmol/L NaCl, 3 mmol/L trisodium citrate). 500 μL of pre-warmed 0.2×SSC was added into the chip and incubated at 55° C. for 20 minutes with gentle shaking. Stringency wash buffer (0.2×SSC) was removed and the chips were rinsed twice with 500 μL 20 mM NaPO₄/100 mM NaCl, pH 7.0 at room temperature.

Next, 500 μL of 50 μM Hoechst 33258 dye (Invitrogen) in 20 mM NaPO₄/100 mM NaCl, pH 7.0 was added into the chip and incubated at room temperature for 15 minutes. The stain was pipetted off and the chip was rinsed twice with 500 μL of 20 mM NaPO₄/100 mM NaCl, pH 7.0 at room temperature. 500 μL of 20 mM NaPO₄/100 mM NaCl, pH 7.0 was added into the chip and incubated at room temperature for 5 minutes. The buffer was pipetted off, and the chip was rinsed twice with 500 μL of 20 mM NaPO₄/100 mM NaCl, pH 7.0. Then, the hybridization chamber was filled with 1 mL of 500 μL of 20 mM NaPO₄/100 mM NaCl, pH 7.0.

The electrochemical analysis (cyclic voltammetry) was carried out with an electrochemical analyzer (Model VMP3) and software from Princeton Applied Research (PAR). The measurement was performed at 100 mV/sec scan rate at room temperature, and the potential sweep range was from +200 mV to 800 mV and back to 200 mV.

### EXAMPLE VII

### Binding of Target Agent (E. coli O157:H7) and Alternative Method of Removal of Excess Capture-associated Oligo Complexes

A sample is obtained from a patient suffering from an E. coli O157:H7 infection and is diluted in PBS/Tween20. An oligonucleotide (capture-associated oligo) conjugated to an anti-E. coli O157:H7 antibody (capture moiety) (the procedure for conjugation is described in Example II) is contacted with the diluted sample by adding a one-third volume of bovine serum albumin (12% [wt/vol] in PBS) and 2 μg of antibody-nucleic acid conjugate (capture-associated oligo complex). The resulting reaction is incubated at room temperature for 30 minutes.

Unbound antibody-nucleic acid conjugates (unreacted capture-associated oligo complexes) are removed by magnetic microparticle depletion. Briefly, magnetic microparticles are coated with a second anti-E. coli O157:H7 antibody (immobilized binding partner), specific to another region (epitope) of the same target agent to be detected. These microparticles are prepared, e.g., as described in Example X. Alternatively, the second antibody (immobilized binding partner) could specifically bind the first antibody/antigen complex (capture moiety/target agent complex). Magnetic beads coated with the second antibody are added to the reaction mixture, in a PBS buffer supplemented with 0.5% BSA and 2 mM EDTA, and incubated at 4° C. for 30 minutes. Only those antibody-nucleic acid conjugates that have bound to E. coli O157:H7 in the sample (reacted capture-associated oligo complexes) are available to bind to the magnetic particle immobilized second anti-E. coli O157:H7 antibody, specific to another region (epitope) of the same target agent to be detected. The magnetically-labeled conjugate is separated from the reaction mixture by adding the mixture to a column packed with lattice-type matrix and applying a magnetic field. Such separation devices are known in the art (e.g., MACS® Columns, Miltenyi Biotec). The magnetically-labeled second antibody-nucleic acid conjugate that is bound to the target agent (immobilized reacted capture-associated oligo complex) is retained on the column. The antibody-nucleic acid conjugate that is not bound to the target agent (unreacted capture-associated oligo complex) will pass through the column.

Subsequently, cleavage of the capture-associated oligo (or a portion thereof) from the magnetically-labeled second antibody-nucleic acid conjugate that is bound to the target agent is performed as described in Example V. This cleavage can be achieved by other approaches, described earlier in this invention. The cleavage products are then subjected to electrochemical detection.

### EXAMPLE VIII

### Binding of Target Agent (Human Anti-Hepatitis Antibodies) without Direct Interaction with the Causative Agent

A sample is obtained from a patient suspected of being infected with hepatitis. The sample is diluted in a diluent such as PBS/tween20. An oligonucleotide conjugated to a hepatitis-specific antigen (or a plurality of different antibodies all specific to different hepatitis-specific antigens) is incubated with the diluted sample by adding a one-third volume of bovine serum albumin (12% [wt/vol] in PBS) and 2 μg of the oligo nucleotide-antigen conjugate (capture-associated oligo complex). Unbound nucleic acid-antigen complex (unreacted capture-associated oligo complex) is removed by magnetic microparticle-antibody affinity depletion. Briefly, magnetic micro-particles are coated with an antibody affinity reagent such as Protein A, Protein G or anti-class antibody which captures antibodies from the sample, a portion of which may be hepatitis antigen specific and bound to the antigen-oligo conjugate. The coated magnetic beads (immobilized binding partner complexes) are added to the reaction mixture, in a PBS buffer supplemented with 0.5% BSA and 2 mM EDTA, and incubated at 40° C. for 30 minutes. Antibodies in the sample will be immobilized on the magnetic beads, but only anti-hepatitis antibodies will contain the oligo-antigen conjugate (i.e., will contain capture-associated oligos). The magnetically-labeled antibody affinity reagent, along with bound oligo-antigen complexes (immobilized reacted capture-associated oligo complexes) are separated from the rest of the sample and extensively washed with PBS/Tween20. Such separation techniques are known in the art (e.g., MACS Columns, Miltenyi Biotec). Subsequent release of the oligo from the antigen is performed as described in Example V and other approaches, described herein.

### EXAMPLE IX

### Creation of Multiple Copies of Capture-associated Oligos (or Complements Thereof) for More Sensitive Detection of the Target Agent via Linear Amplification

An oligonucleotide AminoR-100003-T7 (5′ amino-modified 88 nucleotides long capture-associated oligo) was synthesized using standard phosphoramidite chemistry (Biosearch Technologies, Inc. Novato, Calif.) and was purified as described in Example II, and had the following nucleotide sequence:

5′-ATCTGCAGGCCAGGATGACACCTAGATCGTGGTGATCGGGAGTGTGT
CCACGTGACCAACCCCTATAGCCCTATAGTGAGTCGTATTA- 3′

The oligonucleotide (AminoR-100003-T7, capture moiety) was conjugated to an anti-Mouse α-Human IL-8 Monoclonal Antibody (BD Pharmingen, cat #554716) according to the procedure for conjugation described in Example II. 0.1 mg/mL of the conjugate was obtained. The conjugate therefore contained the AminoR-100003-T7 oligonucleotide (capture-associated oligo) and the anti-Mouse α-Human IL-8 Monoclonal Antibody (capture moiety). In addition, the 3′ end of the capture-associated oligo contained the specific sequence as follows:

5′-CCCTATAGTGAGTCGTATTA-3′

The methods described in Example IV were performed to immobilize reacted capture-associated oligo complexes (i.e., bound to target agent (Human IL-8)) using a second anti-Mouse α-Human IL-8 Monoclonal Antibody (BD Pharmingen cat #550419) binding partner, which was specific to another epitope of the same target agent) immobilized on agarose beads. Urea was added to the beads (agarose beads in 100 μL of PBS from a final step of Example IV) to a final concentration of 1 M. The tube containing all Model System components was incubated for 3 minutes at room temperature. In-Vitro Transcription (IVT) reactions were performed according to the manufacturer's user manual (Ambion MEGAshortscript kit, cat. #1354).

2 μL of the supernatant from the beads with urea in the Model System was taken out and mixed with 2 μL of the T7 primer 2 (250 nM), which is complementary to the 3′ end specific sequence of the capture-associated oligo described earlier in this example: 5′-TAATACGACTCACTATAGGG-3′; the reaction mixture was incubated at 65° C. for 5 minutes and then cooled to 37° C., resulting in hybridization of the complementary synthetic 20-mer T7 primer 2 to the 3′ end of the capture-associated oligo, creating double-stranded recognition sites for T7 RNA polymerase.

In parallel, 2 μL of oligonucleotide AminoR-100003-T7 (250 nM) was annealed with 2 μL of the T7 primer 2 (250 nM) at 65° C. for 5 minutes as the IVT control. Additional components of the In-Vitro Transcription were added to the reaction mixtures according to the manufacturer's user manual (Ambion MEGAshortscript kit, cat #1354) and incubated for 2 hours at 37° C.

After the IVT reactions were completed, a 1:50 dilution of the reaction mixture was made. 3 μL of the diluted transcribed products was mixed with an equal volume of the Gel Loading Buffer, heated at 95° C. for 5 minutes, cooled to room temperature, spun briefly, and loaded onto an 8% TBE/urea denaturing gel system. The gel was stained for 1 minute by SYBR Gold (Invitrogen cat #S11494) by making a 1:10,000 dilution in 1×TBE. The stained gel was rinsed in 1×TBE or Milli-Q water and the image was taken using a UVF BioDoc-It unit. A band, corresponding to the expected size transcript (68 bases long), was observed. Linearly-amplified transcripts were separated from the reacted capture-associated oligo complex by standard techniques such as centrifugation, column purification or ethanol precipitation. Briefly, the resulting mixture was centrifuged at 12,000 r.p.m. in a microcentrifuge for 5 minutes at room temperature. The supernatant, containing the linearly-amplified transcript, was transferred into a separate 1.5 mL microcentrifuge tube. 2.5-3 volumes of 95% ethanol/0.12 M sodium acetate were added to the sample contained in a 1.5 mL microcentrifuge tube, inverted to mix, and incubated in an ice-water bath for 10 minutes. After centrifugation, the supernatant was decanted, and the tube (containing the pelleted material) was drained (by inversion on a paper towel). Ethanol (80%) (corresponding to about two volume of the original sample) was added and the reaction mixture was incubated at room temperature for 5-10 minutes followed by centrifugation for 5 minutes. The supernatant was then decanted. The sample was air-dried and the pellet of nucleic acid (linearly-amplified transcript) was resuspended in 6×SSPE buffer (0.9 M NaCl, 60 mM NaH₂PO₄, and 6 mM EDTA), and was subsequently taken for electrochemical detection.

Alternatively, before the linear amplification reaction, the capture-associated oligo was released from the reacted capture-associated oligo complex by mixing with PstI restriction enzyme. Briefly, 2 μL of the supernatant from the beads with urea in the Model System was taken out and mixed with 2 μL of the Restriction Site Restore Oligo (250 nM), which is complementary to the 5′ end specific sequence of the capture-associated oligo described earlier in this example: 5′-TGTCATCCTGGCCTGCAGAT-3′

The reaction mixture was incubated at 65° C. for 5 minutes and then cooled to 37° C., resulting in hybridization of the complementary synthetic 20-mer Restriction Site Restore Oligo to the 5′ end of the capture-associated oligo, creating double-stranded recognition sites for Pst I restriction enzyme. Restriction digestion with Pst I enzyme (New England Biolabs, cat. #R0140S) was carried out according to the manufacturer's suggested protocol.

After restriction, the Pst I enzyme was heat-inactivated at 80° C. for 20 minutes. Subsequent linear amplification and purification of the linearly-amplified transcript was achieved as described earlier in this example.

### EXAMPLE X

### Preparation of Magnetic Beads with Antibodies Immobilized on the Bead Surface

Magnetic particles (“beads”) may be used as the substrate and antibodies may be attached to form the immobilized binding partner. The use of magnetic beads is well known in the art and these reagents are commercially available from such sources as Ademtech Inc., (New York, N.Y.) and Promega U.S. (Madison, Wis.). “Amino-Adembeads” may be obtained from Ademtech and these beads consist of a magnetic core encapsulated by a hydrophilic polymer shell, along with a surface activated with amine functionality to assist with immobilization of antibodies to the bead surface. The beads are first washed by placing the beads in the included “Amino 1 Activation Buffer,” then this reaction tube is placed in a magnetic device designed for separation. The supernatant is removed, the reaction tube is removed from the magnet, and the beads are resuspended in the included “Amino 1 Activation Buffer.” To assist coupling of the antibody with the magnetic bead, EDC (1-ethyl-3-(3-dimethlaminopropyl)carbodiimide hydrochloride) (4 mg/mL) is dissolved into the included “Amino 1 Activation Buffer”, and an appropriate amount of this solution is added to the beads (80 μL/mg beads), and vortexed gently. 10-50 μg of antibodies is then added per mg of beads, and the solution is vortexed gently. The solution is incubated for 1 to 2 hours at 37° C. under shaking. Bovine serum albumin (BSA) is then dissolved in “Amino 1 Activation Buffer” to a final concentration of 0.5 mg/mL, and 100 μL of this BSA solution is added to 1 mg of antibody-coated beads, and the solution is vortexed gently and incubated for 30 minutes ant 37° C. under shaking. The beads are then washed in the included “Storage Buffer” twice, and the beads are resuspended.

### EXAMPLE XI

### Kits for Use with Linear Amplification

In certain kits, additional kit components are included to allow linear amplification of the isolated nucleic acids prior to introduction of the nucleic acids to the biosensor. Linear amplification can be accomplished by adding the following oligonucleotide (provided in the kit) having the sequence 5′ GAATTCTAATACGACTCACTATAGGG, which reconstitutes a double strand region with the oligonucleotide attached to the capture moiety. Linear amplification is performed by adding the T7 Recombinant RNA polymerase (e.g. T7 R&DNA™ Polymerase from Epicentre Biotechnologies) along with the sufficient amount of dNTPs and reaction buffer (40 mM Tris HCl, 10 mM NaCl, 6 mM MgCl₂, 1 mM spermidine, pH 7.5) to the reaction mixture, and incubating at 37° C. for 30-45 min. An additional vessel within the kit contains the polymerase, the nucleotides and the appropriate buffer.

Linearly-amplified nucleic acid molecules are accumulated in the solution and are separated from the magnetic particle complex by standard techniques such as centrifugation, column purification and ethanol precipitation. Briefly, the resulting mixture is centrifuged at 12,000 rpm in a microcentrifuge for 5 min at room temperature. Transfer the supernatant, containing the linearly amplified nucleic acid, into separate 1.5 ml microcentrifuge tube. 2.5-3 volumes of 95% ethanol/0.12 M sodium acetate are added to the DNA sample contained in a 1.5 ml microcentrifuge tube, invert to mix, and incubate in an ice-water bath for 10 minutes, centrifuge, decant the supernatant, and drain inverted on a paper towel. Ethanol (80%) (corresponding to about two volume of the original sample) is added and the reaction mixture is incubated at room temperature for 5-10 min followed by centrifugation for 5 min. The supernatant is then decanted. The sample is air dried (or alternatively lyophilized) and the pellet of DNA is resuspended in 10 mM Tris-HCl, pH 7.6-8.0, 0.1 mM EDTA. For hybridization reactions, the nucleic acid is resuspended in SSC solution.

Alternatively, before the linear amplification directly from a magnetic particle complex, the nucleic acid could be released from the complex by mixing with a restriction endonuclease such as the EcoRI enzyme. When this is intended, the enzyme can also be included in a separate vessel within the kit. After restriction, the EcoRI enzyme is heat inactivated at 65° C. for 20 minutes. Subsequent linear amplification and purification of the nucleic acid can be achieved as described earlier in this sample.

The linearly amplified nucleic acid thus generated is applied to the diagnostic chip. The amplified nucleic acid is dissolved in 2×SSC (30 mM sodium citrate, 300 mM NaCl, pH 7.0) supplemented with 1 mM EDTA and heated at 70° C. for 3′. The amplified nucleic acid is hybridized to the chip in 2×SSC/EDTA@50° C. for 60 minutes. The chip is stringently washed in 0.2×SSC/EDTA@50° C. for 30 minutes. The array is reacted with 10 mM Hoeschst 33258 in 7 mM sodium phosphate, 180 mM NaCl, pH 7.5 at room temperature in the dark. The anodic peak current (signal) is then read using linear sweep voltammetry by changing the potential from −300 to 900 mV at 100 mV/s.

While this invention is satisfied by embodiments in many different forms, as described in detail in connection with preferred embodiments of the invention, it is understood that the present disclosure is to be considered as exemplary of the principles of the invention and is not intended to limit the invention to the specific embodiments illustrated and described herein. Numerous variations may be made by persons skilled in the art without departure from the spirit of the invention, and other preferred embodiments of the present invention will be apparent to one of ordinary skill in light of the following description of the invention, the drawings, and the claims. The abstract and the title are not to be construed as limiting the scope of the present invention, as their purpose is to enable the appropriate authorities, as well as the general public, to quickly determine the general nature of the invention. The scope of the invention will be measured by the appended claims along with the full scope of equivalents to which such claims are entitled. In the claims that follow, unless the term “means” is used, none of the features or elements recited therein should be construed as means-plus-function limitations pursuant to 35 U.S.C. §112, ¶6. All publications mentioned herein are cited for the purpose of describing and disclosing reagents, methodologies and concepts that may be used in connection with the present invention. Nothing herein is to be construed as an admission that these references are prior art in relation to the inventions described herein. Throughout the disclosure various patents, patent applications and publications are referenced. Unless otherwise indicated, each is incorporated by reference in its entirety for all purposes.

1. A device for determining the presence of one of a discrete subset of target agents in a test sample, wherein the device comprises:
a) a first chamber containing a plurality of capture-associated oligo complexes, each capture moiety having the ability to specifically bind to a single target agent of the subset of target agents in a sample; and
b) a second chamber comprising an excess of binding partners for isolation of unreacted capture-associated oligo complex, wherein the target agents are immobilized on a solid surface.

2. A device for determining the presence of target agents in a test sample, wherein the device comprises:
a) a first chamber containing a plurality of capture-associated oligo complexes that preferentially bind to the target agent; and
b) a second chamber comprising a plurality of binding partners that preferentially bind to the target agent.

3. A kit for determining the presence of one of a discrete subset of target agents in a test sample, said kit providing:
a) a vessel containing a plurality of capture-associated oligo complexes, wherein each capture moiety can specifically bind to a single target agent of the discrete subset of agents;
b) a second vessel comprising an excess of binding partners immobilized to a surface, wherein the binding partners preferentially bind the unreacted capture-associated oligo complexes; and
c) a biosensor comprising a plurality of biosensor-associated oligos, wherein each biosensor-associated oligo is complementary to a capture-associated oligo.

4. The kit of claim 3, wherein the capture moieties are antibodies.

5. The kit of claim 3, wherein the capture moieties are ligands.

6. The kit of claim 3, further comprising a vessel containing a restriction endonuclease.

7. The kit of claim 3, wherein the restriction endonuclease cleaves a double stranded site.

8. The kit of claim 3, further comprising a vessel containing a minor groove binding ligand for visualization of nucleic acid duplex molecules.

9. A kit for determining the presence of one of a discrete subset of target agents in a test sample, said kit providing:
a) a vessel containing a plurality of capture-associated oligo complexes, wherein each capture moiety can specifically bind to a single target agent of the discrete subset of target agents in a sample;
b) a second vessel comprising an excess of binding partners immobilized to a surface, wherein the binding partners preferentially bind the unreacted capture-associated oligo complexes; and
c) a biosensor comprising a plurality of biosensor-associated oligos, wherein each biosensor-associated oligo has substantially the same sequence as the binding region of a capture-associated oligo.

10. The kit of claim 9, wherein the capture moieties are antibodies.

11. The kit of claim 9, wherein the capture moieties are ligands.

12. The kit of claim 9, further comprising a vessel containing a restriction endonuclease.

13. The kit of claim 9, further comprising a vessel containing with a minor groove binding ligand for visualization of nucleic acid duplex molecules.

14. The kit of claim 9, further comprising a vessel holding with an oligonucleotide complementary to a polymerase recognition sequence on the capture-associated oligo.

15. The kit of claim 9, further comprising an RNA phage polymerase.

16. The kit of claim 9, further comprising a heat stable polymerase.

17. The kit of claim 15, wherein the RNA phage polymerase is selected form the group consisting of T3 polymerase, T7 polymerase, and SP6 polymerase.

18. A kit for determining the presence of one of a discrete subset of target agents in a test sample, said kit providing:
a) a vessel containing a plurality of capture-associated oligo complexes, wherein each capture moiety can specifically bind to a single target agent of the discrete subset of target agents in a sample;
b) a second vessel comprising an excess of binding partners immobilized to a surface, wherein the binding partners preferentially bind the unreacted capture-associated oligo complexes; and
c) a biosensor comprising a plurality of biosensor-associated oligos, wherein each biosensor-associated oligo is complementary to a capture-associated oligo.

19. The kit of claim 18, wherein the capture moieties are antibodies.

20. The kit of claim 18, wherein the capture moieties are ligands.

21. The kit of claim 18, further comprising a vessel containing a restriction endonuclease.

22. The kit of claim 18, further comprising a vessel containing with a minor groove binding ligand for visualization of nucleic acid duplex molecules.

23. A kit for determining the presence of one of a discrete subset of target agents in a test sample, said kit providing:
a) a vessel containing a plurality of capture-associated oligo complexes, wherein each capture moiety can specifically bind to a single target agent of the discrete subset of target agents in a sample;
b) a second vessel comprising an excess of binding partners immobilized to a surface, wherein the binding partners preferentially bind the unreacted capture-associated oligo complexes; and
c) a biosensor comprising a plurality of biosensor-associated oligos, wherein each biosensor-associated oligo is complementary to a capture-associated oligo.

24. The kit of claim 23, wherein the capture moieties are antibodies.

25. The kit of claim 23, wherein the capture moieties are ligands.

26. The kit of claim 23, further comprising a vessel containing a restriction endonuclease.

27. The kit of claim 23, further comprising a vessel containing with a minor groove binding ligand for visualization of nucleic acid duplex molecules.

28. The kit of claim 23, further comprising a vessel containing an oligonucleotide complementary to a polymerase recognition sequence on the capture-associated oligo.

29. The kit of claim 23, further comprising a vessel comprising a polymerase.

30. The kit of claim 29, wherein the vessel contains both an oligonucleotide and a polymerase.

31. The kit of claim 29, wherein the polymerase is a heat stable polymerase.

32. The kit of claim 29, wherein the polymerase is an RNA phage polymerase is selected form the group consisting of T3 polymerase, T7 polymerase, and SP6 polymerase.

33. The kit of claim 23, further comprising nucleotides.

34. A kit for determining the presence of one of a discrete subset of agents in a test sample, said kit providing:
a) a vessel with at least two chambers, wherein the vessel comprises:
i) a first chamber containing a plurality of capture-associated oligo complexes, each capture moiety having the ability to specifically bind to a single target agent of the subset of target agents in a sample;
ii) a second chamber comprising an excess binding partners for isolation of unreacted capture-associated oligo complex, wherein the target agents are immobilized on a solid surface; and
b) a biosensor comprising a plurality of biosensor-associated oligos, wherein each biosensor-associated oligo is complementary to a capture-associated oligo.

35. The kit of claim 34, wherein the capture moieties are antibodies.

36. The kit of claim 34, wherein the capture moiety are ligands.

37. The kit of claim 34, further comprising a vessel containing a restriction endonuclease.

38. The kit of claim 34, wherein the restriction endonuclease cleaves a double-stranded site.

39. The kit of claim 34, further comprising a vessel containing with a minor groove binding ligand for visualization of nucleic acid duplex molecules.

40. A kit for determining the presence of one of a discrete subset of agents in a test sample, said kit comprising:
a) a single vessel with at least two chambers, wherein the vessel comprises:
i) a first chamber containing a plurality of capture-associated oligo complexes, each capture moiety having the ability to specifically bind to a single target agent of the subset of target agents in a sample;
ii) a second chamber comprising an excess of binding partners for isolation of unreacted capture-associated oligo complex, wherein the target agents are immobilized on a solid surface; and
b) a biosensor comprising a biosensor-associated oligo, wherein the biosensor-associated oligo is complementary to the capture-associated oligo.

41. The kit of claim 40, wherein the capture moiety is an antibody.

42. The kit of claim 40, wherein the capture moiety is a ligand.

43. The kit of claim 40, further comprising a vessel containing a restriction endonuclease.

44. The kit of claim 40, wherein the restriction endonuclease cleaves a double-stranded site.

45. The kit of claim 40, further comprising a vessel containing with a minor groove binding ligand for visualization of nucleic acid duplex molecules.

46. The kit of claim 40, further comprising a vessel containing an oligonucleotide complementary to a polymerase recognition sequence on the capture-associated oligo.

47. The kit of claim 40, further comprising a vessel comprising a polymerase.

48. The kit of claim 46, wherein the vessel contains both an oligonucleotide and a polymerase.

49. The kit of claim 47 wherein the polymerase is a heat stable polymerase.

50. The kit of claim 47, wherein the polymerase is an RNA phage polymerase is selected form the group consisting of T3 polymerase, T7 polymerase, and SP6 polymerase.

51. The kit of claim 40, further comprising nucleotides.

52. A kit for determining the presence of a target agent in a test sample, said kit comprising:
a) a single vessel with at least two chambers, wherein the vessel comprises:
i) a first chamber containing a plurality of capture-associated oligo complexes that preferentially bind to the target agent; and
ii) a second chamber comprising a plurality of binding partners that preferentially bind to the target agent; and
b) a biosensor comprising a biosensor-associated oligo, wherein the biosensor-associated oligo is complementary to the capture-associated oligo.

53. A kit for determining the presence of a target agent in a test sample, said kit comprising:
a) a single vessel with at least two chambers, wherein the vessel comprises:
i) a first chamber containing a plurality of capture-associated oligo complexes that preferentially bind to the target agent; and
ii) a second chamber comprising a plurality of binding partners that preferentially bind to the target agent; and
b) a biosensor comprising a biosensor-associated oligo, wherein the biosensor-associated oligo has substantially the same sequence as the binding region of a capture-associated oligo.

54. A kit for determining the presence of a target agent in a test sample, said kit comprising:
a) a single vessel with at least two chambers, wherein the vessel comprises:
i) a first chamber containing a plurality of capture-associated oligo complexes that preferentially bind to the target agent to form reacted capture-associated oligo complexes; and
ii) a second chamber comprising a plurality of binding partners that preferentially bind to the reacted capture-associated oligo complexes; and
b) a biosensor comprising biosensor-associated oligos, wherein the biosensor-associated oligos are complementary to capture-associated oligos.

55. A kit for determining the presence of a target agent in a test sample, said kit comprising:
a) a single vessel with at least two chambers, wherein the vessel comprises:
i) a first chamber containing a plurality of capture-associated oligo complexes that preferentially bind to the target agent to form reacted capture-associated oligo complexes; and
ii) a second chamber comprising a plurality of binding partners that preferentially bind to the reacted capture-associated oligo complexes; and
b) a biosensor comprising a biosensor-associated oligo, wherein the biosensor-associated oligo has substantially the same sequence as the binding region of a capture-associated oligo.

56. A kit for detection of a target agent in a sample, comprising
a) a vessel containing a capture-associated oligo complex, wherein the capture moiety specifically binds to the target agent; and
b) a biosensor comprising a biosensor-associated oligo, wherein the biosensor-associated oligo is complementary to the capture-associated oligo.

57. A kit for detection of a target agent in a sample, comprising
a) a vessel holding a capture moiety conjugated to a capture-associated oligo, wherein the capture moiety specifically binds to the target agent; and
b) a biosensor comprising a biosensor-associated oligo, wherein the biosensor-associated oligo has substantially the same sequence as the binding region of the capture-associated oligo.
